(19) United States
(12) Patent Application Publication
(10) Pub. No.: US 2007/0283528 A1
(43) Pub. Date: Dec. 13, 2007

(54) Door hinge template

(76) Inventors: Steven D. McDaniel, Humboldt, TN (US); Joseph Calvin King IV, Jackson, TN (US); Jeremy Lippenholz, Cockeysville, MD (US); Dustin Lee, Eldorado, OH (US)

Correspondence Address: BRAKE HUGHES BELLERMANN LLP, c/o INTELLEVATE, P.O. BOX 52050, MINNEAPOLIS, MN, 55402, US

(21) Appl. No.: 11/729,540

(22) Filed: Mar. 29, 2007

Related U.S. Application Data
(60) Provisional application No. 60/787,450, filed on Mar. 30, 2006.
(60) Provisional application No. 60/809,294, filed on May 30, 2006.
(60) Provisional application No. 60/841,509, filed on Aug. 31, 2006.
(60) Provisional application No. 60/901,735, filed on Feb. 16, 2007.

(51) Int. Cl. E06B 7/00; E05D 15/00; E06B 1/52

(52) U.S. Cl. 16/221; 144/372

(57) ABSTRACT

A door hinge template may include a body defining a central portion and at least one alignment portion that extends from the central portion. The door hinge template may include an opening defined in the central portion, the opening configured to guide a cutting instrument to form the mortise for the hinge in a surface of a door jamb and in a corresponding surface of a door frame. First and second substantially parallel alignment surfaces may be disposed on opposite sides of each of the at least one alignment portions, wherein the first alignment surface may be configured to abut against the surface of the door when forming the mortise in the door jamb and the second alignment surface may be configured to abut against the surface of the door frame when forming the mortise in the door frame.

### CROSS-REFERENCE TO RELATED APPLICATIONS

This application claims priority under 35 U.S.C. § 119 to: (i) U.S. Provisional Application No. 60/787,450, filed on Mar. 30, 2006, and titled, “DOOR HINGE TEMPLATE,” (ii) U.S. Provisional Application No. 60/809,294, filed on May 30, 2006, and titled, “DOOR HINGE TEMPLATE,” (iii) U.S. Provisional Application No. 60/841,509, filed on Aug. 31, 2006, and titled, “GAP SPACER FOR DOOR HINGE TEMPLATE,” and (iv) U.S. Provisional Application No. 60/901,735, filed on Feb. 16, 2007, and titled, “DOOR HINGE TEMPLATE WITH ADJUSTABLE HINGE SIZING,” all of which are incorporated herein by reference in their entirety.

### TECHNICAL FIELD

This description relates to a door hinge template, and, in particular, to a door hinge template used to guide a cutting instrument to create mortises in a door and door frame for installation of a hinge.

### BACKGROUND

Hanging a door on hinges within a door frame is a precise task that is prone to error. When done properly, the door fits snugly within the door frame when closed, with well-defined gaps around all four edge surfaces of the door. Further, when done properly, the door swings open freely on the hinges, and may stay open at any intermediate position between fully closed and fully open (assuming no other constraints are in place). In short, the door will be level, balanced, well-positioned, and secure.

In practice, it may be difficult for either professional or amateur woodworkers to achieve these results, particularly in a repeatable or reliable manner. For example, if a woodworker attempts to position the hinges by measuring associated distances, then the smallest error in measurement may cause an undesirable and noticeable offset when hanging the door. Even if one door is hung well, the process of doing so may be lengthy and difficult, and the woodworker may nevertheless have to seek to repeat the process (e.g., when installing multiple doors in a house, so that the different doors appear uniform with one another).

Consequently, door hinge templates have been developed that seek to provide woodworkers with fast, easy, reliable techniques for hanging doors in door frames. Generally, door hinge templates are used to guide a cutting instrument, e.g., a router, to form a recess (also known as a mortise) for a hinge in an edge surface of a door and in the facing surface of a door frame. That is, such door hinge templates may be used to form a first mortise in the surface of the door frame, and a second mortise in the facing edge surface of the door, so that first and second hinge portions, respectively, may fit thereinto. In this way, the door may be hung within the door frame in a desired fashion.

Door hinge templates are designed to ensure that the first and second mortises are aligned with one another in a manner that ensures that surfaces of the door and door frame that face each other are substantially coplanar with one another, in both vertical and horizontal directions. Moreover, the door hinge templates should also ensure that the door and door frame are flush with one another when the door is closed. In short, the door hinge template is designed to ensure that doors may be hung within door frames in a manner that is precise, straight-forward, and repeatable, and that minimizes reliance on human alignment, estimation, or measurement. In practice, existing or conventional door hinge templates have reduced, but not eliminated, reliance on human judgment and ability.

### SUMMARY

In one aspect, a template has a body defining a central portion and at least one alignment portion that extends from the central portion. An opening is defined in the central portion and is configured to guide a cutting instrument to form the mortise for the hinge in a surface of a door jamb and in a corresponding surface of a door frame. The body is configured such that mortises on the door jamb and the door frame can be formed without rotating the orientation of the template.

Implementations of this aspect may include one or more of the following features. The template has first and second substantially parallel alignment surfaces disposed on opposite sides of each of the at least one alignment portions. The first alignment surface is configured to abut against the surface of the door when forming the mortise in the door jamb and the second alignment surface is configured to abut against the surface of the door frame when forming the mortise in the door frame. One or more pins are extendable through the body. The pins may extend beyond the first alignment surface when the first alignment surface abuts the surface of the door jamb and the pins may extend beyond the second alignment surface when the second alignment surface abuts against the surface of the door frame. The body defines a plurality of apertures for receiving the pins, each aperture corresponding to a door size.

In another aspect, a template has a body defining a central portion and at least one alignment portion that extends from the central portion. Each alignment portion has an alignment surface configured to abut against at least one of a surface of the door jamb and a surface of the door frame when forming mortises for a hinge in the door jamb and the door frame. An opening is defined in the central portion and is configured to guide a cutting instrument to form the mortise for the hinge in at least one of the surface of the door jamb and the surface of the door frame. An insert member is receivable in one or more of a plurality of positions with respect to the opening and has a guide surface configured to change the size and/or shape of the opening. The insert member has a first attachment member that is removably attachable to a second attachment member disposed on the body. The first and second attachment member are located remote from the guide surface. By moving the first and second attachment members away from the guide surface, bouncing by the router bit guide bearing is less of a concern, so that the first and second guide members can be made larger, and thus less fragile and less prone to breakage.

Implementations of this aspect may include one or more of the following. The guide member has a curvature to form a mortise with a curved corner. The first attachment member includes a flange extending from the guide member and a tooth on the flange. The second attachment member includes a recess in the body configured to receive the tooth on the flange. The first and second guide members are positioned to reduce bouncing by a router bit guide bearing. The tooth has a width of approximately 3/16 inches and the recess has a width of approximately 3/16 inches.

In another aspect, a method of creating a door hinge mortise in a door jamb includes: moving an alignment member of a door hinge template to a position that corresponds to a width of the door jamb without removing the alignment member from the door hinge template; placing an alignment surface of the door hinge template against the door jamb so that the alignment member abuts against an edge of the door jamb; and guiding a cutting implement along walls of an opening in the door hinge template to form the mortise in the door jamb.

In another aspect, a method of creating a door hinge mortise in a door jamb and a corresponding door hinge mortise in a door frame includes: placing a door hinge template against the door jamb; guiding a cutting implement along walls of an opening in the door hinge template to form the door hinge mortise in the door jamb; placing the door hinge template against the door jamb without changing the orientation of the door hinge template relative to the door jamb and door frame; and guiding a cutting implement along walls of an opening in the door hinge template to form the door hinge mortise in the doorjamb. In an implementation, placing the door hinge template against the door jamb includes placing a first surface of the door hinge template against the door jamb. In another implementation, placing the door hinge template against the door frame includes placing a second, parallel surface of the door hinge template against the door frame.

In an aspect, a template has a body defining a central portion and at least one alignment portion that extends from the central portion. Each alignment portion has an alignment surface configured to abut against at least one of a surface of the door jamb and a surface of the door frame when forming mortises for a hinge in the door jamb and the door frame. An opening is defined in the central portion and is configured to guide a cutting instrument to form the mortise for the hinge in at least one of the surface of the door jamb and the surface of the door frame. An alignment member extends from each of the alignment surfaces. Each alignment member is configured to abut against an edge of at least one of the door jamb and the door frame to position the opening relative to the door jamb or the door frame. Each alignment member is moveable between at least two positions to accommodate at least two different sized doors without removing the alignment member from the template.

Implementations of this aspect may include one or more of the following features. The template has two alignment portions extending in opposite directions from the central portion. A plurality of walls define the opening. The alignment member includes a rotatable dial disposed above the alignment surface and a projection that extends below the alignment surface. The projection is L-shaped to accommodate two sizes of doors. The projection may be pin shaped, may be triangular to accommodate three sizes of doors, or may be four sided to accommodate four sizes of doors. The alignment portion includes a slot and the alignment member includes a slidable tab that fits into the slot, and is slidable between two or more discrete positions in the slot.

Advantages may include one or more of the following. The template can be more accurately aligned with the door jamb and door frame using projections that abut against the edge of the door jamb and the door frame. The projections can be moved between positions without removing the projections from the body so that they will not become separated from the template and misplaced or lost. The template may be used with the door jamb and door frame without rotating the template to a different orientation. The template insert tabs may be larger, and thus more resistant to breakage by positioning them further from the cutout aperture, which reduces the effects of bouncing from the router bit guide bearing. Other advantages and features will be apparent from the description, the drawings, and the claims.

### BRIEF DESCRIPTION OF THE DRAWINGS

FIGS. 1A and 1B are top and bottom views of an implementation of a hinge template.

FIGS. 2A and 2B are side detailed views of the pin and nail of the hinge template of FIGS. 1A and 1B.

FIG. 3 is a perspective view of a door hinge template with a gap spacer.

FIG. 4 is a first enlarged view of the door hinge template with a gap spacer of FIG. 3 being used to position a first mortise for a hinge.

FIG. 5 is a second enlarged view of the door hinge template with a gap spacer of FIG. 3 being used to position a second mortise for a hinge.

FIG. 6 is a side view of an example implementation of the door hinge template of FIG. 3.

FIG. 7 is a perspective view of the example implementation of the door hinge template of FIG. 6.

FIGS. 8 and 9 illustrate an example embodiment of the door hinge template of FIG. 3 in which the gap spacer is provided with indexing recesses.

FIG. 10A is a perspective view of an implementation of a template connecting system.

FIGS. 10B-10C are close-up perspective views of portions of the template connecting system of FIG. 10A.

FIGS. 11A-11B are end views of the template connecting system of FIG. 10A.

FIG. 12 is a side view of a portion of the template connecting system of FIG. 1A.

FIG. 13 is a perspective view of a door hinge template providing an adjustable hinge size using a ratcheting finger mechanism.

FIGS. 14A and 14B are more detailed illustrations of the relative sizes and distances used in providing the ratcheting finger mechanism of FIG. 13.

FIGS. 15A and 15B are cut-away views of a connection of the ratcheting finger mechanism within corresponding slots of the door hinge template of FIG. 13.

FIG. 16 is a cut-away view of a die mold for forming the ratcheting finger mechanism of FIG. 13.

FIG. 17 is a perspective view with selected blow-ups of a locking pin mechanism for setting selectable door widths using a hinge template.

FIGS. 18A and 18B are cut-away views illustrating the locking pin mechanism of FIG. 17.

FIG. 19 is a perspective view of the door hinge template of FIG. 13 including the gap spacer of FIG. 3.

FIGS. 20A and 20B are top and bottom views of an implementation of a hinge template.

FIGS. 21A-21D are schematic views of the hinge template of FIG. 20, showing the alignment member in four different positions.

FIGS. 22A and 22B are perspective views of the alignment member of the hinge template of FIG. 20.

FIG. 23 is a perspective view of an another implementation of a hinge template.

### DETAILED DESCRIPTION

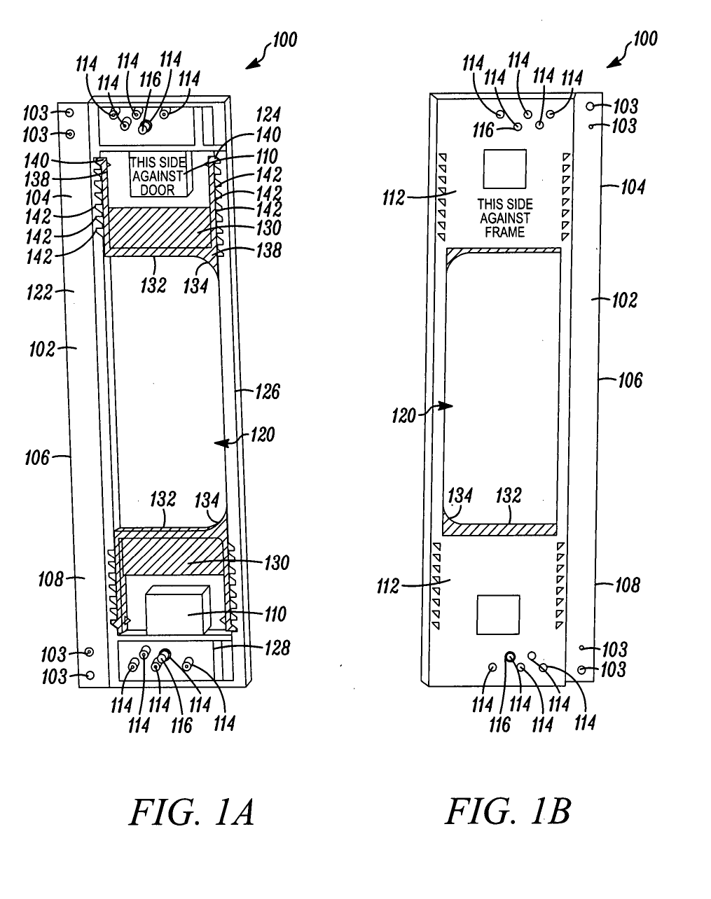

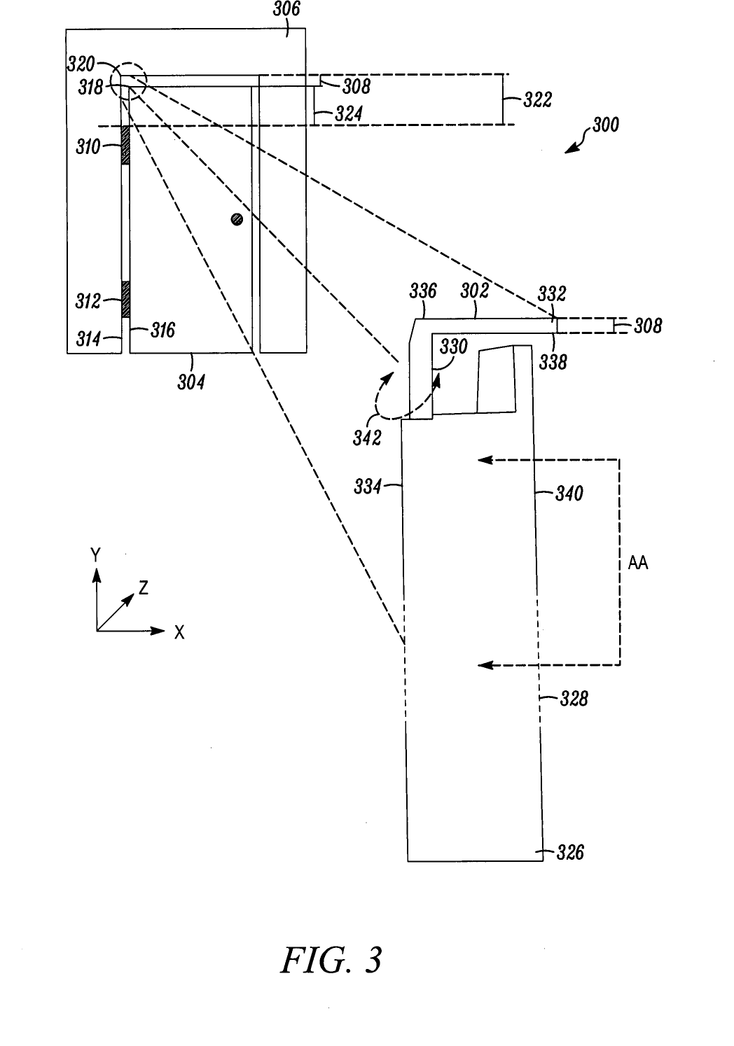

Referring to FIGS. 1A and 1B, a hinge template 100 is illustrated. Usage examples of the hinge template 100, or variations thereof, in the context of an example door and door frame are provided below, e.g., with respect to FIG. 3. In general, though, the hinge template 100 includes a body 102 having a top alignment portion 104, a central portion 106, and a bottom alignment portion 108. Body 102 includes a door jamb alignment surface 110 and a frame alignment surface 112. Alignment surfaces 110 and 112 are substantially parallel and located on opposite faces of the body 102. Doorjamb alignment surface 110 is configured to abut against the surface of the door jamb when forming the mortise in the door jamb, and frame alignment surface 112 is configured to abut against the surface of the door frame when forming the mortise in the door frame. At the edges of body 102 are a plurality of nail holes 103, each of which are sized and configured to receive a nail 105 therethrough to attach the body 102 to a doorjamb or door frame.

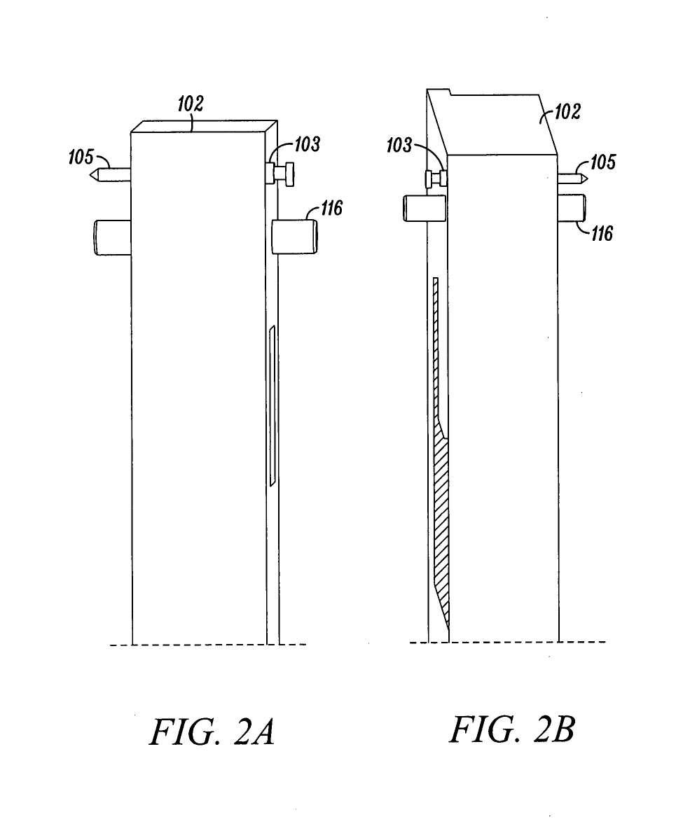

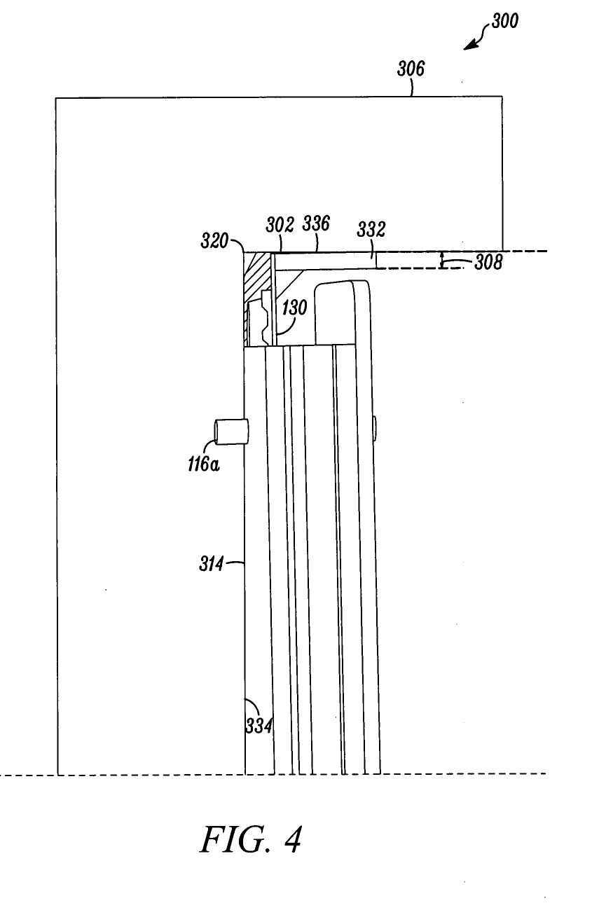

Each of the top and bottom alignment portions 104, 108 define a plurality of throughbores 114 that each may receive one of a pair of alignment pins 116. Each of the throughbores 114 is located at a different distance from an edge of template 100 to correspond to different sizes of doors. The pins 116 are positioned in the throughbores 114 that are appropriate for the size of the door in which the mortise is being created. Referring also to FIGS. 2A and 2B, the pins 116 extend beyond both alignment surfaces 110 and 112. In an embodiment, pins 116 are slidable in throughbores 114 so that pins 116 may extend from the throughbores 114 or may be positioned flush with one of the alignment surfaces 110 and 112 so as to not interfere with the movement of the router base over the alignment surface that is not abutting the door jamb or door frame. Further description and examples of the structure and use of throughbores 114 and the alignment pins 116 are provided below, e.g., with respect to FIGS. 4, 5, 14, 18, and 19

Referring to FIGS. 1A and 1B, central portion 106 defines a generally rectangular opening 120 that is surrounded by a plurality of walls 122, 124, 126, 128. Received in opening 120 are a pair of inserts 130, each having a side wall 132 and a curved corner 134. Each insert 130 also has a pair of extension legs 138 that each terminate in one or more teeth 140. Walls 122 and 126 each have a plurality of slots 142 that are configured to receive the teeth 140 to adjust the position of the inserts 130 relative to the opening 120, and thus, adjust the effective size of the opening 120. Template 100 may include a plurality of inserts 130 that correspond to a plurality of hinge sizes and configurations. Teeth 140 are advantageously disposed a distance from side wall 132 so as to reduce the risk of bouncing of the router bit guide bearing when the router bit guide bearing strikes the walls 122, 124, 126, 128 and/or the side wall 132 of insert 130. Because the risk of bouncing is reduced, the teeth 140 and their corresponding slots 142 may be made larger in size, e.g., approximately 3/16 inches in width, so as to avoid a risk of breakage of teeth 140.

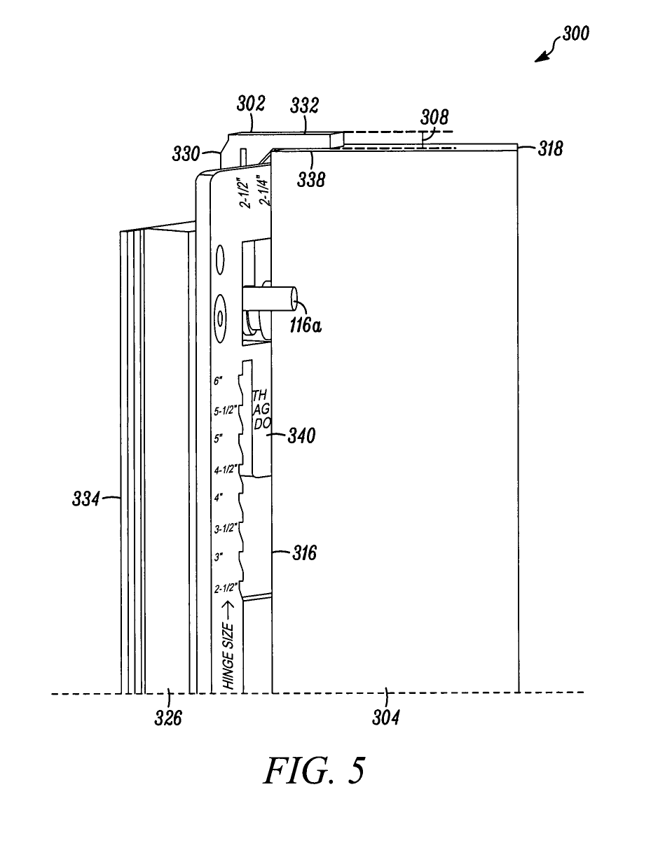

In use, door alignment surface 110 is placed against the side surface of a doorjamb D (also illustrated in FIG. 5 with respect to door 304). Pins 116 are positioned in the throughbores 114 that correspond to the size of the door. The template 100 is then aligned with the inside edge of the door jamb D by causing the pin 116 to abut against the inner door edge with an edge of body 102 overhanging the edge of the doorjamb. The template 100 is then affixed to the door jamb D by driving nails 105 through nail holes 103 (see FIG. 2A). The walls around opening 120 are used to guide a cutting instrument, such as a router, to cut a mortise for a hinge into the door jamb. Once the door mortise is complete, the template 100 is removed from the door jamb D and the nail is removed from the nail hole 103. The template 100 is then placed against the side surface of the door frame F with the pins 116 abutting against the inner edge of the frame F (also illustrated in FIG. 4 with respect to door frame 306). The template 100 is affixed to the door frame F by driving the nails 105 through the nail holes 103 in an opposite direction as with the door jamb D (see FIG. 2B). The walls around opening 120 are used to guide a cutting instrument, such as a router, to cut a mortise for a hinge into the door frame F.

As described and illustrated herein, with the door jamb alignment surface 110 and the frame alignment surface 112 being opposed to one another on opposite sides of the door hinge template 100, the door hinge template 100 allows a user to move directly from the door to the frame when mounting the door hinge template 100 with the nails 103, without having to rotate the door hinge template 100 to do so. Consequently, the possibilities of misalignments or other difficulties that may be associated with such a rotation of a hinge template may be minimized or avoided. Further, the alignment pins 116 help reduce or eliminate a requirement for a user to visually align the door hinge template 100 with either the door jamb or door frame, since the user may rely instead on the abutment of the alignment pin 116 against the door jamb or door frame to establish and maintain a proper alignment of the door hinge template 100.

FIG. 3 is a perspective view of a door hinge template 300 with a gap spacer 302. The gap spacer 302 may be used to ensure that a door 304 fits within a frame 306 in the manner referenced above, e.g., to ensure that the door 304, when hung, is level, balanced, well-positioned, and secure, and to ensure that a method of hanging the door 304 is precise, straight-forward, and repeatable, and minimizes reliance on human alignment, estimation, or measurement. In so doing, as explained in more detail below, the door hinge template 300, and the gap spacer 302, ensure that a gap distance 308 is accurately set to a desired distance/amount.

In the example of FIG. 3, the door 304 and the door frame 306 are provided to explain and illustrate a function and operation of the gap spacer 302 (and, more generally, of the hinge templates 300 and 100). Consequently, the illustration of the door 304 and the door frame 306 is simplified and abbreviated for these purposes, and so it should be understood that many additional or alternative features thereof may be included. For example, the frame 306 may have molding or other trim that is not shown in the example of FIG. 3.

Since the gap spacer 302 is explained with reference to the door 304 and door frame 306, FIG. 3 illustrates various specific features and elements thereof that may be useful for this purpose. For example, in FIG. 3, a top hinge 310 and a bottom hinge 312 are illustrated that serve to join a vertical surface 314 of the door frame with a vertical edge surface 316 of the door. Of course, other numbers of hinges may be used than the two illustrated in the example of FIG. 1, depending on a nature and function of the door 304.

As shown, the gap distance 308 is defined between an upward-facing or top edge surface 318 of the door 304, and between a downward-facing or bottom surface 320 of the door frame 306. Of course, it will be appreciated that relative terms such as “upward” or “downward” are used here for illustration and with respect to the specific example of FIG. 3, and that other terms may be more suitable in other contexts. For example, the door 304 may be attached to the door frame 306 with the hinges 310, 312 along a top surface of the door, so that the door 304 pivots about an axis parallel to the surface 320. In this case, the gap distance 308 may be defined between the surfaces 314, 316, rather than between the surfaces 318, 320.

Thus, the gap distance 308 also may be viewed with regard to a first distance 322 between a top of the hinge 310 and the surface 320 of the door frame 306, compared to a second distance 324 between a top of the hinge 310 and the edge surface 318 of the door 304. Thus, the difference between these two distances is the gap distance 308. For common residential doors, a typical gap distance may be, for example, ⅛^{th} of an inch, or 1/16^{th} of an inch, although a desired gap may vary based on installer preference or on an intended use of the door 304.

In practice, when hanging the door 304, the distances 322, 324 may be thought of as being defined not with respect to the hinge 310 itself, but rather with respect to a mortise(s) (not visible in FIG. 3) in which the hinge 310 ultimately will be positioned and fastened. That is, during installation, the hinge 310, by definition, has not yet been positioned, and one of the goals of the installation is to define and cut the mortise(s) for the hinge 310 in a desired and proper position, e.g., as described above with respect to FIGS. 1A-2B.

In this regard, conventional aspects of door hinge templates may be used to guide the definition and cutting of a first mortise(s) in the surface 314 of the door frame 306 and a second mortise in the edge surface 316 of the door 304. As is known, these first and second mortises should be cut with a length, width, and depth that are suitable to receive and inset complementary pieces of the hinge 310.

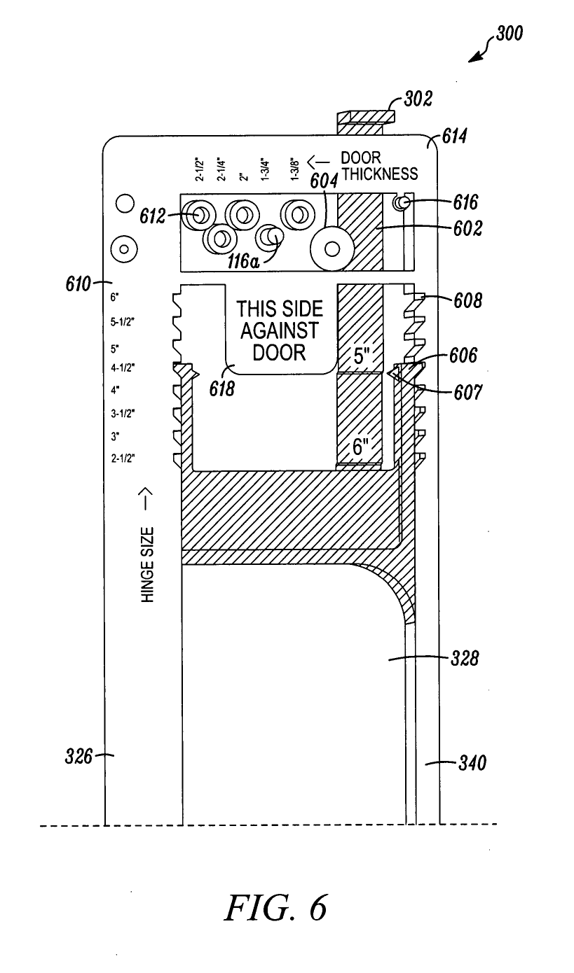

For example, the door hinge template 300 may include a body 326 having an opening 328 (which corresponds generally to the opening 120 of the example of FIGS. 1A-2B, and which should be understood to represent one or more openings, as needed). The opening 328 is not visible from the side view of FIG. 3, and is only connoted in FIG. 3 by dashed lines, but may be seen, for example, in FIG. 6 (taken along line AA illustrated in FIG. 3).

Such an opening as the opening 328, as with the opening 120, above, may serve as an alignment window(s) defining a cutout aperture, which a woodworker may use to guide a router or other cutting instrument and thereby define and cut the mortise(s) for hanging the door 304. As is known, different alignment windows may be used for different sized doors or hinges. Further, although not shown in FIG. 3, nail assemblies (such as the nail assemblies 103, above) may be used to hold the door hinge template 300 in place during the routing or other cutting of the mortises using the alignment windows (e.g., the opening 328). Thus, the distances 322, 324 also may be considered to exist or be defined with respect to the opening(s) 328 within the door hinge template 300, when the door hinge template 300 is positioned as described herein to form the mortise(s).

In practice, then, a woodworker may begin by positioning the door hinge template 300 in contact with both the side surface 314 and the bottom-facing surface 320 of the door frame 306 (i.e., in the corner of the door frame 306 illustrated within the dashed circle of FIG. 3). In this position, the gap spacer 302 is in the defined corner and abuts the surface 320. More specifically, a first (vertical) member 330 of the gap spacer 302 is offset from the surface 314, while a second (perpendicular, horizontal) member 332 is in contact with the surface 320. Thus, a (side) surface 334 of the door hinge template 300 that runs along the body 326 is in contact with the surface 314 of the frame 306, while a surface 335 of the gap spacer 302 is offset from the surface 314 and the surface 334. A (top) surface 336 of the door hinge template 300, shown as the horizontal member 332 of the gap spacer 302, is in contact with the surface 320 of the frame 306. In other words, the L-shaped gap spacer 302 fits into the designated corner of the door frame 306, but with an offset from the surface 314. The described position of the door hinge template 300 and the gap spacer 302 relative to the door frame 306 is illustrated in more detail in FIG. 4.

While in this position, a woodworker may easily and reliably attach the door hinge template 300 to the door frame 306. As will be appreciated, no measurement or alignment by the woodworker is required; rather, the door hinge template 300 is simply positioned as described, and pushed against the surfaces 314, 320. Then, the woodworker may temporarily attach the door hinge template 300 to the surface 314 (e.g., using nails 103 through the nail assemblies thereof, as just referenced), and, while thus attached, may use a router or other cutting instrument to cut a (first) mortise within the bounds or constraints of the appropriate alignment window(s) (e.g., the opening 328) of the body 326.

Then, a similar operation is performed in which the door hinge template 300 is positioned in contact with the door 304, or, more specifically, is positioned in contact with the edge surface 316 and the top edge surface 318, i.e., at the corner of the door illustrated within the dashed circle of FIG. 3. In this position, a (bottom) surface 338 of the horizontal member 332 of the gap spacer 302 is in contact with the top edge surface 318 of the door 304. Simultaneously, a vertical side surface 340 of the body 326 abuts the side edge surface 316 of the door 304. This position of the door hinge template 300 and the gap spacer 302 relative to the door 304 is illustrated in more detail in FIG. 5.

As before, no measurement or alignment by the woodworker need be associated with obtaining the described position. Rather, again, the woodworker may simply place the door hinge template 300 in the described position, with the surfaces 338, 340 contacting the surfaces 316, 318, and thereafter proceed with attaching (e.g., nailing) the door hinge template 300 so as to use the opening 328 or other alignment window to guide a cutting of the mortise to be formed in the edge surface 316 of the door 304.

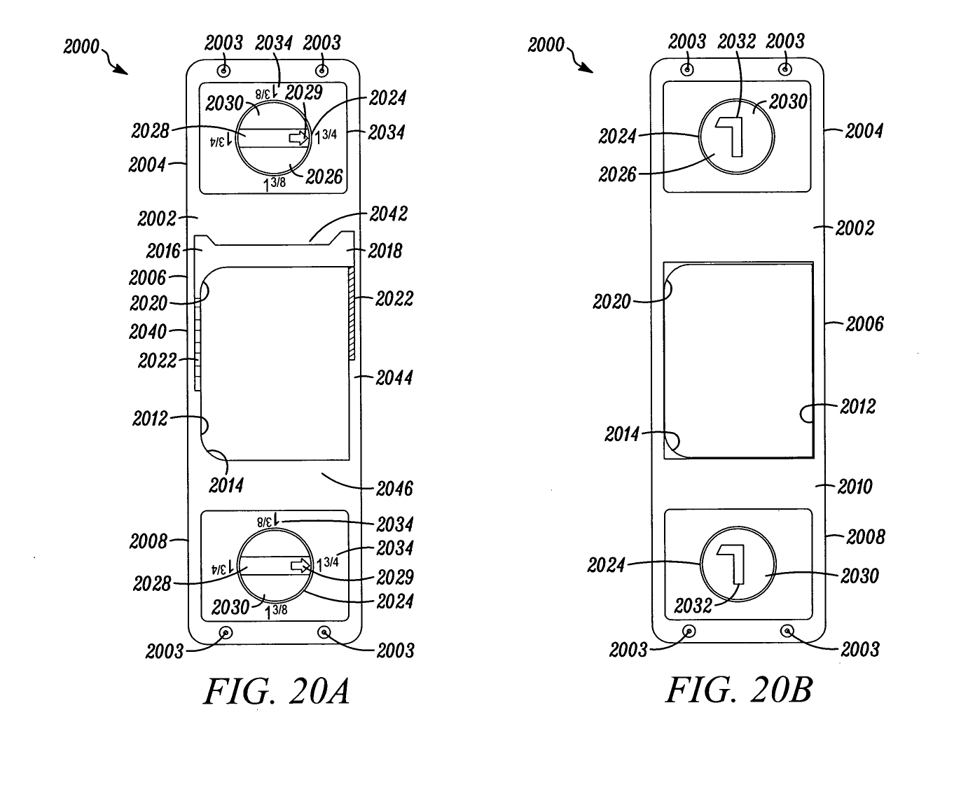

Thus, the door hinge template 100 provides for accurate positioning of corresponding mortises in a “y” direction (with reference to the illustrated axes of FIG. 3, in which a “y” direction extends parallel to the surfaces 314, 316, an “x” direction extends parallel to the surfaces 318, 320, and a “z” direction extends perpendicular to the “x” and “y” directions (i.e., through a depth of the door frame 306). In various example implementations, it may be helpful or necessary to also position the mortise accurately in the “z” direction, i.e., within/along a depth of the door frame 306 and/or of the door 304. Such positioning/alignment may be done visually, or may use a separate but complementary alignment technique (e.g., the alignment pin 116 such as that illustrated in FIGS. 1A-2B, as well as with respect to FIGS. 4, 5, 14, 18, and/or 19, below, or some other alignment technique, such as the alignment adjustment knob 2026 of FIGS. 20-22, below).

Also, in the example of FIG. 3 and in following examples, below, the door hinge template 300 is described such that operation thereof involves placing the surface 334 of the door hinge template 300 against the surfaces 314, 320 of the door frame 306, and then placing the surface 340 of the door hinge template 300 against the surfaces 316, 318 of the door 304. In other words, the surface 334 may be seen to be analogous to the frame alignment surface 112 of FIGS. 1A and 1B, while the surface 340 may be seen to be analogous to the doorjamb alignment surface 110 of FIGS. 1A and 1B. Thus, the door hinge template 300 may be seen as incorporating some or all of the features and advantages described above with respect to the door hinge template 100, as well as additional or alternative features and advantages (e.g., the gap spacer 302).

In other example implementations, however, a single surface or side of the door hinge template 300 may be placed against both pairs of surfaces, e.g., the door hinge template 300 may be required to be rotated 180 degrees in between defining the first mortise for the door frame 306 and defining the second mortise for the door 304. In such implementations, or in additional or alternative example implementations, the gap spacer 302 may rotate in a manner illustrated by circular line 342 in FIG. 3, e.g., may rotate about an axis through the member 330. Such an implementation may be useful, for example, when the (same) surface 334 is to be placed against both the surfaces 314, 320 of the door frame 306, as well as against the surfaces 316, 318 of the door 304. In such implementations, for example, the alignment adjustment knob 2026 of FIGS. 20-22 may be used to provide alignment for various widths of doors in the “z” direction, instead of the alignment pin 116.

Thus, by including the gap spacer 302 having a thickness that is equivalent to a desired gap distance 308, the woodworker may easily and consistently hang the door 304 and other doors. The door hinge template 300 may be manufactured in different versions or models, corresponding to different gap distances. For example, a first door hinge template 300 may be formed in which the member 332 is ⅛^{th} of an inch (so that the gap distance 308 will also be ⅛^{th} of an inch), or may be formed in which the member 332 is 1/16^{th} of an inch (so that the gap distance 308 will also be 1/16^{th} of an inch). In other example implementations, the gap spacer 302 may be adjustable or interchangeable with other parts or pieces, not shown in FIG. 1, that allow the woodworker to select a desired gap distance from a plurality of options or possibilities.

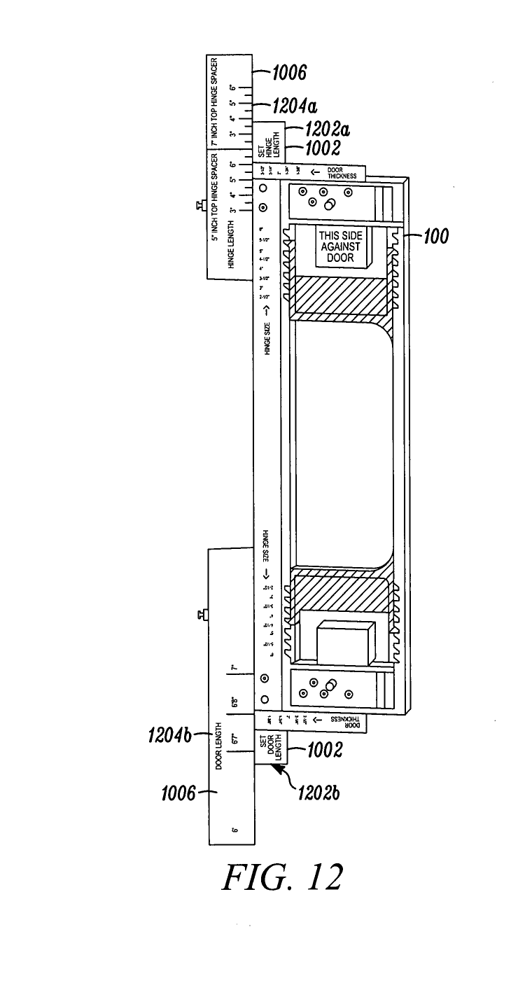

As described, the gap spacer 302 may be used with the door hinge template 100 of FIGS. 1A and 1B, or variations thereof, or may be used with other door hinge templates. The following examples of FIGS. 4-7 illustrate example implementations in which the door hinge template 300 is substantially similar to the door hinge template 100, but with the inclusion of the gap spacer 302. However, other example implementations, such as described with respect to FIGS. 12-21, include additional or alternative features for a door hinge template, which may be used with or without the gap spacer 302. In short, it will be appreciated that the various example features and functions of the various door hinge templates described herein may be used in many different combinations with one another, and with other combinations of features not explicitly discussed herein, as would be apparent.

FIG. 4 is a first enlarged view of the door hinge template 300 with the gap spacer 302 of FIG. 3, being used to position a first mortise for the hinge 310. In FIG. 4, and consistent with the examples above, the surface 336 of the member 332 of the gap spacer 302 contacts the surface 320 of the door frame 306. Simultaneously, the surface 334 of the body 326 of the door hinge template 300 contacts the surface 314 of the door frame 306. Consequently, when the door hinge template 300 is fixed in the illustrated position, a first mortise may be cut into the surface 314 of the door frame 306.

Also in FIG. 4, an alignment pin 116a is illustrated that may be used to align the door hinge template in a “z” direction, in much the same manner as the alignment pin 116 of FIGS. 1A-2B. For example, as may be appreciated from the discussion of FIGS. 1A-2B, above, the alignment pin 116a may be slidable in an “x” direction. Then, in FIG. 4, the alignment pin 116a may be slid in a direction of the surface 314 of the door frame 306, so that when the door hinge template 300 is moved in a “z” direction, the protruding alignment pin 116a (i.e., an inner surface thereof, not visible in FIG. 4) stops the motion of the door hinge template at a defined position. As apparent from the discussion herein, including with reference to the illustration of FIG. 3, the alignment pin 116a may thus be used to ensure that the door hinge template 300 is aligned or calibrated in a “z” direction, so that, for example, the as-installed door 304 will be flush with a desired surface or plane of the door frame 306. The ability of the alignment pin 116a to slide or adjust to varying depths also allows the door hinge template to be positioned in a desired manner, even when molding or other trim is used on the door frame 306.

FIG. 5 is a second enlarged view of the door hinge template 300 with the gap spacer 302 of FIG. 3 being used to position a second mortise for a hinge. In FIG. 5, and consistent with the examples above, the surface 338 of the member 332 of the gap spacer 302 contacts the surface 318 of the door 304. Simultaneously, the surface 340 of the body 326 of the door hinge template 300 contacts the surface 316 of the door 304. Consequently, when the door hinge template 300 is fixed in the illustrated position, a second mortise may be cut into the surface 316 of the door 304.

As shown in FIG. 5, the alignment pin 116a may be slid in an “x” direction and positioned in contact with an outer edge of the door 304. Thus, and analogously to the use of the alignment pin 116a in FIG. 4 (as well as with respect to FIGS. 1A-2B), the alignment pin 116a may align or calibrate the door hinge template 300 in a “z” direction, so that the door 304, when installed, will be flush with a desired surface or plane of the door frame 306.

The sliding operation of the alignment pin 116a is consistent with the above description of the door hinge template 300 being used to position both the first mortise (of the door frame 306) and the second mortise (of the door 304), without rotating the door hinge template 300 in between. That is, as shown, the surface 334 may be used when aligning the first mortise, while the surface 340 may be used when aligning the second mortise (again, similarly to the surfaces 110 and 112 of FIGS. 1A and 1B). In other additional or alternative example implementations, however, the same surface (e.g., the surface 334) may be used in contact with the surface 314 and the surface 316 (e.g., the door hinge template 300 may be rotated 180 degrees between aligning the first and second mortises). In still further additional or alternative examples, as referenced above, the gap spacer 302 may rotate 180 degrees, e.g., to allow the same surface 334 to be used during both alignment procedures. Of course, in the various examples discussed, and in other examples, the opening 328, and/or other features of the door hinge template 300, may be selected appropriately to ensure a desired alignment.

As illustrated again by FIGS. 4 and 5, operation and use of the door hinge template 300 requires essentially no alignment or measurement by the woodworker installing the door 304. The woodworker merely needs first to press and maintain the door hinge template 300 into the desired corner of the door frame 306 (and form the first mortise), using the gap spacer 302 and alignment pin 116a, and then press and maintain the door hinge template 300 over the desired corner of the door 304 (and form the second mortise), also using the gap spacer 302 and alignment pin 116a. In this way, many sources of human error and inaccuracy may be mitigated or removed, and a task of the woodworker may be made easier and more consistent.

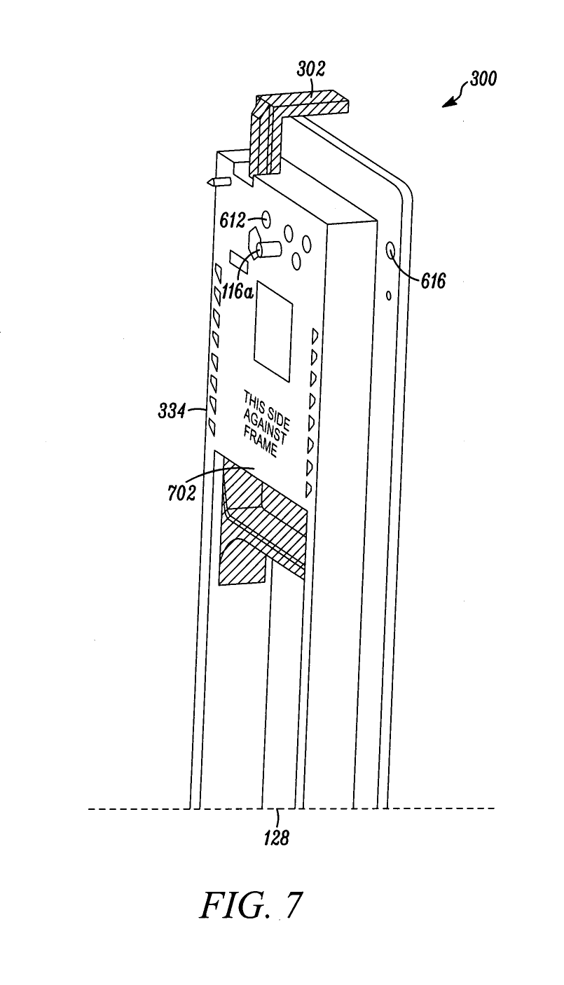

FIGS. 6 and 7 are different views of an example implementation of the door hinge template 300 of FIG. 3, i.e., which is consistent with the description of the door hinge template 100 of FIGS. 1A-2B but which includes the gap spacer 302 of FIG. 3. FIG. 6, in particular, illustrates a view of the door hinge template 300 of FIG. 3 taken along line AA. More generally, FIGS. 6 and 7 illustrate several of the features referenced above but not specifically illustrated in the context of FIGS. 3-5, as well as additional or alternative features, that may be used with the gap spacer 302 of FIG. 3.

For example, in FIG. 6, the gap spacer 302 extends along a member 602, which has or shares the member 330 illustrated in FIG. 3. As shown, the member 602 may be secured into a desired position by a rotatable clamp mechanism 604. Together, the member 602 and the clamp 604 form a gap setup guide that defines the distance 322 (shown in FIG. 3) between the surface 320 and a top of the hinge 310 (or first mortise). The clamp 604 may include, for example, a knob with a threaded hole, so that a threaded stud attached to the door hinge template 300 and a corresponding washer may be used to secure the member 602 in place. In practice, then, the woodworker may loosen the clamp 604, adjust/slide the member 602 to a desired distance for the distance 322, and then re-secure the clamp 604 at the desired distance. In the example of FIGS. 6 and 7, distances of 5″ and 6″ are illustrated, but it should be apparent that a continuum of distances may be set by an appropriate use of the clamp 604.

Further in FIG. 6, a tabbed member or insert 606 is illustrated that selectively fits into recesses 608. As shown by hinge size markings 610, the tabbed member 606 may thus be used to select a desired size of the opening 328, and, thereby, a desired size of the resulting mortise (and associated hinge) to be formed (ranging, in the examples of FIGS. 6 and 7, as in the example of FIG. 1A, between 2½″ and 6″). Thus, a similar structure is illustrated as shown in FIGS. 1A and 1B, where the insert 130 is illustrated as having teeth 140 on extension leg 138 fitting into recesses or slots 142. More generally, it will be appreciated from the above description that FIGS. 6 and 7 include a number of such features that are described above in detail, but that are not necessarily labeled or discussed here with respect to FIGS. 6 and 7. Rather, FIGS. 6 and 7 further illustrate an inclusion and incorporation of the gap spacer 302 in the example context that is similar to that of FIGS. 1A-2B, including, for example, a tab 607 that points to a marked distance on the member 602 that is attached to the gap spacer 302, when the member 602 is positioned using the clamp 604, as just described.

Apertures 612 correspond to throughbores 114 of FIGS. 1A and 1B, and similarly provide adjustability and choice for placement of the alignment pin 116a. As should be apparent from the nature, function, and description of the alignment pin 116a provided above, the apertures 612 allow the woodworker to position the mortises in one of a number of available positions in the “z” direction. Door thickness markings 614 provide the woodworker with a choice of depth settings in this regard (ranging, in the examples of FIGS. 6 and 7, between 1⅜″ and 2½″), and, with the alignment pin 116a, allow the woodworker to install varying thickness of the door 304 even where molding or other trim of the door frame 306 may be present.

Nail assembly 616, similar to nail holes 103 of FIGS. 1A-2B, illustrates an example of a nail assembly with included nail that may be used to position the door hinge template 300 temporarily while cutting the mortise(s) in the door frame 306 and/or the door 304. Finally in FIGS. 6 and 7, a marking 618 (stating, in the example, “this side against door”) indicates that the illustrated side (i.e., the surface 340) should be placed against the door 304. Meanwhile, a marking 702 on the surface 134 may be used to indicate the proper placement of the surface 334 against the door frame 306 (where the marking 702 states, in this example, “this side against frame”). Consistent with the explanations and illustrations above, the markings 618 and 702 provide additional techniques for ensuring that the door hinge template 300 is used properly, and reduces or eliminates another potential source of human error.

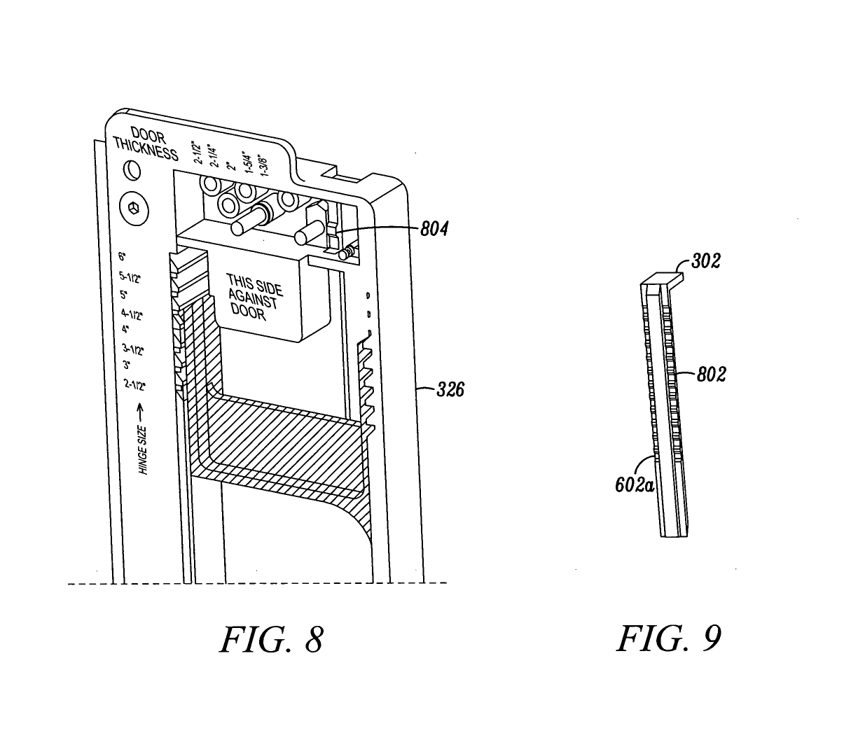

FIGS. 8 and 9 illustrate an example embodiment of the door hinge template 300 of FIG. 3 in which the gap spacer 302 is provided with indexing recesses. As referenced above with regard to FIGS. 6 and 7, a gap setup guide for defining the distance 322 may include the member 602 and the clamp 604, and, in those examples, such a gap setup guide provides for a continuum of possibilities for the distance 322. However, as will be appreciated from the description and illustration of FIG. 6, positioning of the member 602 relies on friction and/or on the appropriate tightening of the clamp 604. Consequently, the member 602 may move undesirably during placement of the door hinge template 300 against the door frame 306 or the door 304.

In the example of FIGS. 8 and 9, the gap spacer 302 includes a member 602a in which indexing recesses 802 are formed. The indexing recesses 802 may be mated during operation with an indexing tab 804 on the body 326 of the door hinge template 300. In this way, a plurality of discrete distances 322 may be selected, and the indexing tab 804 and indexing recesses 802 may be used to secure the member 602a thereat.

Many other features and advantages of the door hinge template 300, not discussed explicitly herein, may be provided. For example, the door hinge templates 100 or 300 may be made of metal (e.g., steel), or may be made of molded plastic, or other suitable material.

As a further example(s), when installing a plurality of aligned hinges, a plurality of the door hinge templates 100 or 300 may be joined together in a row, so that, for example, an alignment/calibration of a top door hinge template 300 using the gap spacer 302 will automatically align all of the attached door hinge templates 300 or 100, or other door hinge templates, as well.

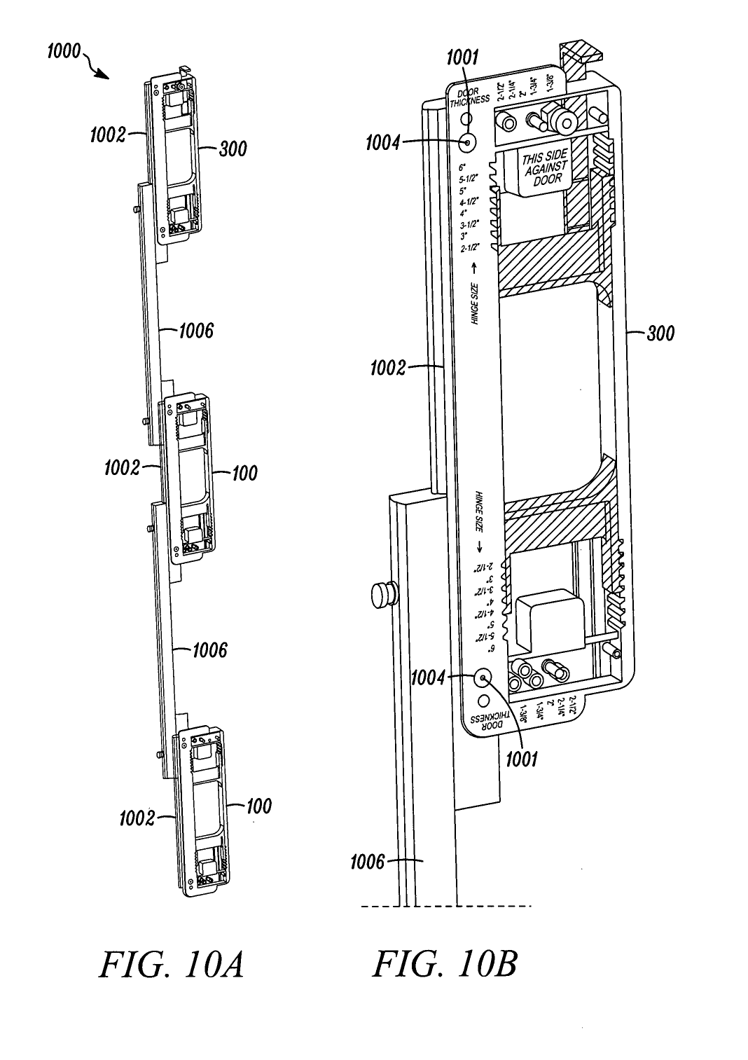

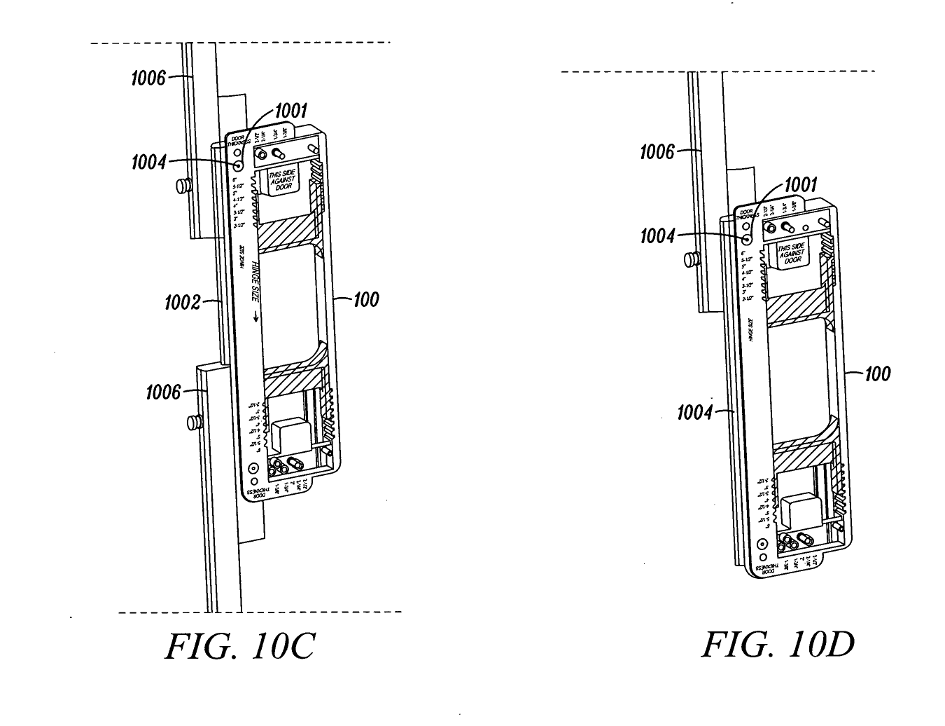

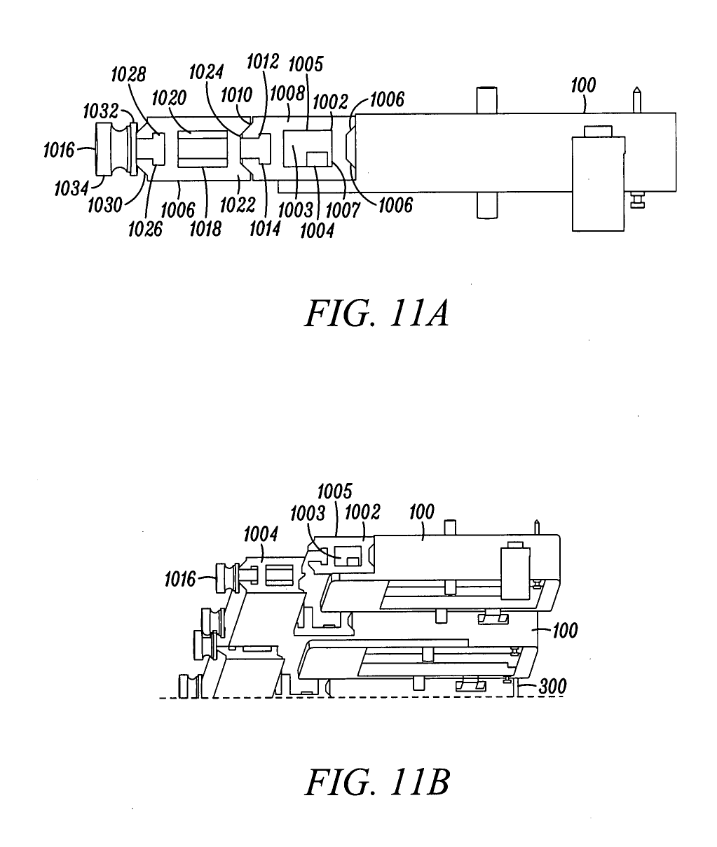

For example, referring to FIGS. 10A-10D, at the edges of body 102 of template 100 (or of template 300), there may be a plurality of screw holes 1001 for attaching multiple templates 100/300 to one or more elongated members in order to create multiple mortises in a doorjamb or door frame without having to move a single template along the door frame or door jamb. For example, a template connecting system 1000 includes connecting members 1002 (e.g., an elongated metal or plastic extrusion) attached to each of three templates 100/300 by screws 1004, and linking members 1006 (e.g., an elongated metal or plastic extrusion) that link adjacent connecting members 1002. Referring also to FIGS. 11A and 11B, each connecting member 1002 has a body portion 1005 defining a channel 1003, a pair of legs 1009 extending from body portion 1005 that are adjacent to template 100/300, and apertures 1007 in body portion 1005 for receiving screws 1004. Also extending from body portion 1005 are a pair of generally C-shaped arms 1008 with angled exterior surfaces 1010 and that together define a channel 1012 for receiving a flanged portion 1014 of a tightening bolt 1016.

Each linking member 1006 includes a body portion 1018 defining a channel 1020, and a pair of legs 1022 extending from body portion 1018 with angled surfaces 1024 that abut against the angled exterior surfaces 1010 of arms 1008. Body portion 1018 also defines a through hole 1026 that receives the shaft 1028 of tightening bolt 1016. Also extending from body portion 1018 are a pair of arms 1030 that project inwardly and that have an angled upper surface 1032 that are configured to abut against the knob 1034 of tightening bolt 1016. The connecting member 1002 and the linking member 1006 can be made using the same extrusion die.

In use, the templates 100/300 are attached to their respective connecting members 1002 by screws 1004. The connecting members 1002 are positioned adjacent linking members 1006 with flanged portions 1014 of tightening bolts 1016 received in channels 1012 defined by C-shaped arms 1008. The lengthwise position of the connecting members 1002 relative to the linking members 1006 are adjusted for the door size and hinge size and the tightening bolts 1016 are tightened.

As shown, the template 300 with the gap spacer 302 may suitably be used at a top position where the gap distance 308 is to be defined. Meanwhile, the template 100 may be used for lower templates/mortises/hinges, where there is not a need to define the gap distance 308.

Thus, a plurality of hinge templates may be provided with the connecting member 1002, which may be welded, screwed, or otherwise attached to the respective hinge template. Then, as shown, the connecting member 1002 may be slid into, and nested within, the linking member(s) 1006, and fastened at a desired position using a suitable knob, screw, pin, or other attachment mechanism. This construction allows for the provision of the hinge templates 100/300 in a straight line and in a desired number (e.g., 3 or 4 hinge templates) to provide a corresponding number of hinges needed for hanging a given door.

In example embodiments, the connecting members 1002 and linking members 1006 may be extruded aluminum, and may all have the same (respective) extruded profile(s). By using the same profile, tooling cost can be kept to a minimum, since, for example, the same extrusion tool can be used for all the connecting member 1002. Thus, in operation, the connecting member 1002 slides easily into the mated linking member 1006.

FIG. 12 is a perspective view of an example of the door hinge template(s) 100/300 of FIGS. 10A-11B showing markings based on hinge length and door length. In this regard, it will be appreciated that a spacing of the three (or four, or more) hinge templates 100/300 relative to one another should be easy to setup, so that, for example, the respective hinge mortises may be spaced at distances that are frequently used by door installers.

There are at least two factors that may affect this required spacing. For example, one such factor is a hinge length of the hinge that is desired to be installed. That is, for example, with longer hinges, the templates 100/300 may need to be spaced closer together for a given door size than may be the case for relatively shorter hinges.

As shown in FIG. 12, the connecting member 1002 may have a mark for setting a hinge length relative to an end 1202a of the connecting member 1002, and the linking member 1006 may have corresponding options illustrated by marks 1204a corresponding to different hinge sizes. As shown, different options may be provided for different hinge sizes/spaces, and may be provided with respect to how the hinge(s) will be positioned, e.g., as a top, middle, or bottom hinge. For example, in FIG. 12, markings 1204a are provided for a 5 inch top hinge spacer and a 7 inch top hinge spacer.

FIG. 12 also illustrates markings based on door length. For example, with a longer door, the hinge templates 100/300 generally should be spaced further apart from one another than with respect to a relatively shorter door. Thus, a second factor for positioning the hinge templates 100/300 relative to one another is a length of the door to be installed. For example, in FIG. 12, the door hinge template 100 is illustrated as using an end 1202b of the connecting member 1002 to align with markings 1204b on the linking member 1006 for various door lengths, as shown.

As shown by FIG. 12, then, one end of each connecting member 1006 has marks 1204b for the door length, while the other end of each connecting member 1006 has marks 1204a for the hinge length. In this way, the templates 100/300 may be used easily and reliably to install hinges in a desired position for a number of different hinge and door sizes.

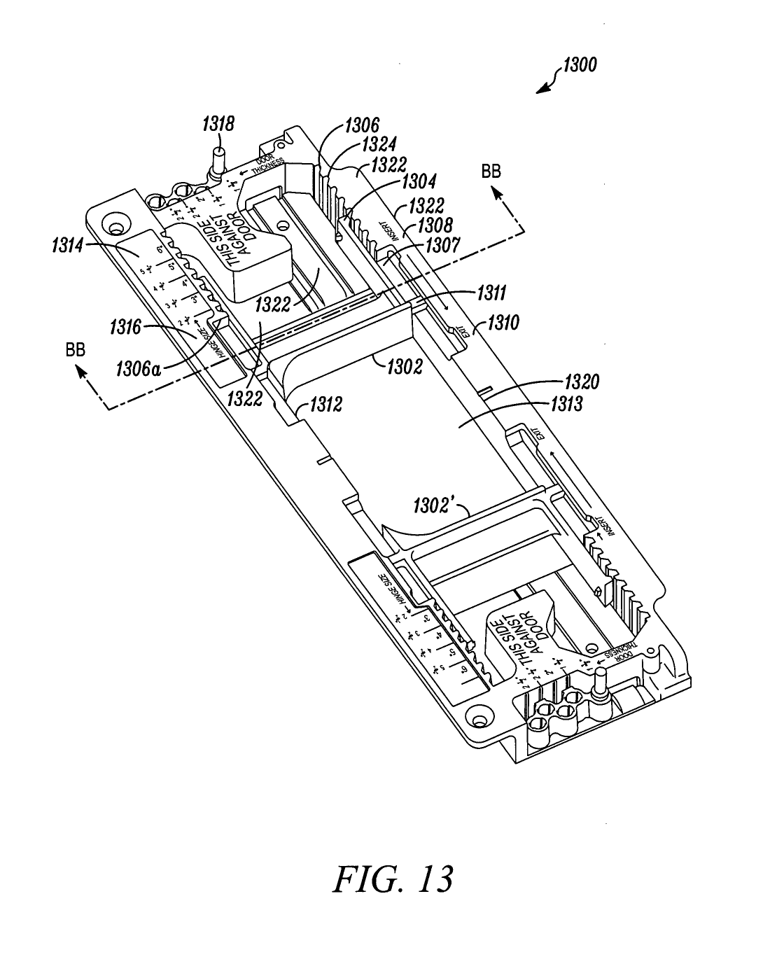

FIG. 13 is a perspective view of a door hinge template 1300 providing an adjustable hinge size using a ratcheting finger mechanism. An example of such a ratcheting finger mechanism is provided above, for example, with regard to FIG. 4, and with regard to elements 406 and 408, as described above. Specifically, as described above, the tabbed member 406 is illustrated in FIG. 4 as selectively fitting into recesses 408. As shown by hinge size markings 410 of FIG. 4, the tabbed member 406 may thus be used to select a desired size of the opening 128 of FIG. 1, and, thereby, a desired size of the resulting mortise (and associated hinge) to be formed.

FIG. 13 provides a similar mechanism with respect to hinge sizing member 1302 having tabbed member(s) or finger(s) or teeth 1304 fitting into slots or recesses 1306 (analogously to teeth 140 fitting into slots 142 of FIG. 1, or teeth 606 fitting into slots 608 of FIG. 6). In FIG. 13, however, a track 1307 is included having an insert point 1308 and an exit point 1310. As shown, the track 1307 maintains a tab 1311 in place within the hinge template 1300 as the hinge sizing member 1302 slides within the hinge template 1300 and within a corresponding slot 1312 on an opposite side of the hinge template 1300. In this way, the hinge sizing member 1302 may be prevented from moving in or out of an opening 1313 of the hinge template 1300 in an undesirable manner.

In FIG. 13, similarly to FIGS. 1A and 6, markings 1314 and 1316 correspond to maximum and minimum hinge sizes, respectively, e.g., 6 inches and 2.5 inches, also respectively. In the example of FIG. 13, the hinge sizing member 1302 may be inserted at the maximum size of 6 inches at the marking 1314, so that the tab 1311 fits into the insert point 1308, and then the fingers 1304 may be ratcheted down through the various recesses 1306 until a desired hinge size is reached. Later, the hinge sizing member 1302 may be removed from the hinge template 1300 by ratcheting the hinge sizing member 1302 and fingers 1304 through any remaining recesses 1306 and then removing the tab 1311 through the exit point 1310.

In this way, the ratcheting finger track design of FIG. 13 constrains the ratcheting fingers 1304 in proper orientation to the hinge template 1300 as the hinge template 1300 ratchets to different hinge size settings, and keeps the fingers 1304 in place while the user works with the template 1300.

Further in FIG. 13, an alignment pin 1318 is illustrated that may be set, for example, to correspond to different door widths. In this regard, the alignment pin 1318 is similar in function to the alignment pin 116 or FIG. 1A-2B, and the alignment pin 116a of FIGS. 4 and 5, but, as illustrated and explained in more detail below, includes a locking mechanism that may provide for more secure and reliable function of the hinge template 1300 in aligning hinges for various door widths.

Finally in FIG. 13, a center line(s) 1320 is illustrated that is positioned at a centered position between the hinge sizing member 1302 and a corresponding, bottom hinge sizing member 1302′. Center line(s) 1320 may be scribed, molded, painted or otherwise placed on the template 1300 at the midpoint of opening 1313.

The center line 1320 may be used, for example, to assist the user in finding the center location of the template 1300 and drawing a corresponding line to mark this center point. The user may then use the marked center line to position the template in the correct location, e.g., on the door or on the door frame/doorjamb. For example, the user may draw a line on the door frame where the center of the mortise is to be cut. Then, to accurately position the template 1300, the user may place the center line 1320 of the opening 1313 over the line on the door frame. The center line 1320 also may be used to check if the template 1300 has moved from its desired position by comparing the position of the center line 1320 with the line drawn by the user on the door frame.

Although the above discussion is primarily provided with respect to the hinge sizing member 1302 that may be used to align a top half or portion of a hinge or mortise, it will be appreciated that corresponding comments may generally apply also to a corresponding hinge sizing member 1302′ that may be used to position a bottom half or portion of the hinge or mortise. Thus, corresponding structure of the hinge template 1300 associated with the hinge sizing member 1302′ is not generally discussed in further detail herein.

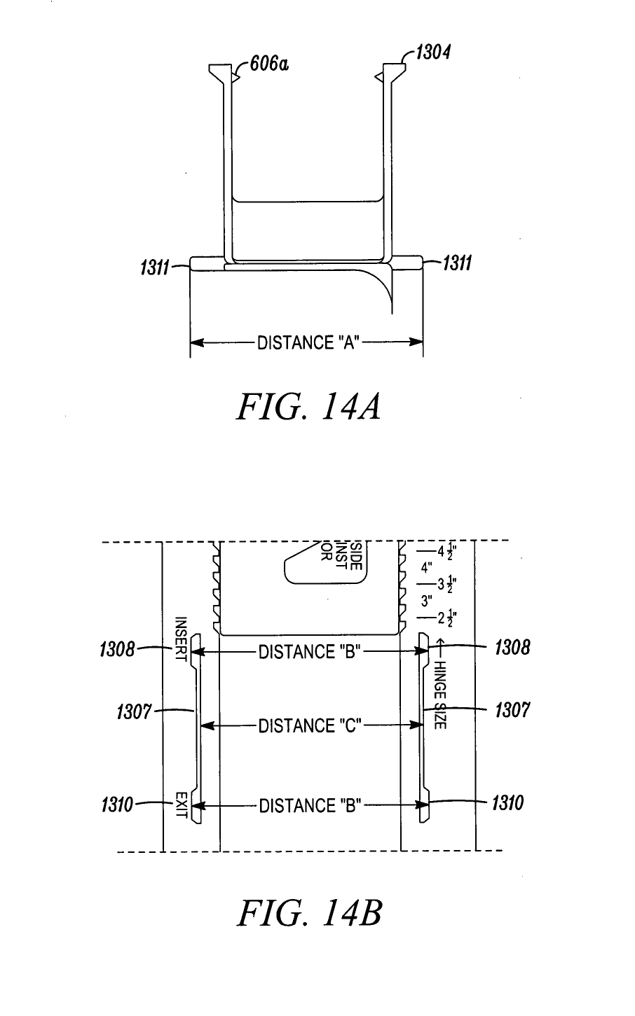

FIGS. 14A and 14B are more detailed illustrations of the relative sizes and distances used in providing the ratcheting finger mechanism of FIG. 13. In FIG. 14A, a distance “A” corresponds to a distance between tabs 1311. Meanwhile, in FIG. 14B, distance “B” corresponds to a distance between outer walls of the insert points 1308, and also the distance between the exit points 1310. A distance “C” corresponds to a distance between the tracks 1307. As may thus be appreciated from FIGS. 14A and 14B, distance “B” is larger than distance “A,” which allows the tabs 1311 to pass thru the insert point 1308 and through the exit points 1310 of the template 1300. Meanwhile, the distance “C” is smaller than the distance “A,” thus keeping the finger 1304 constrained in the track 1307.

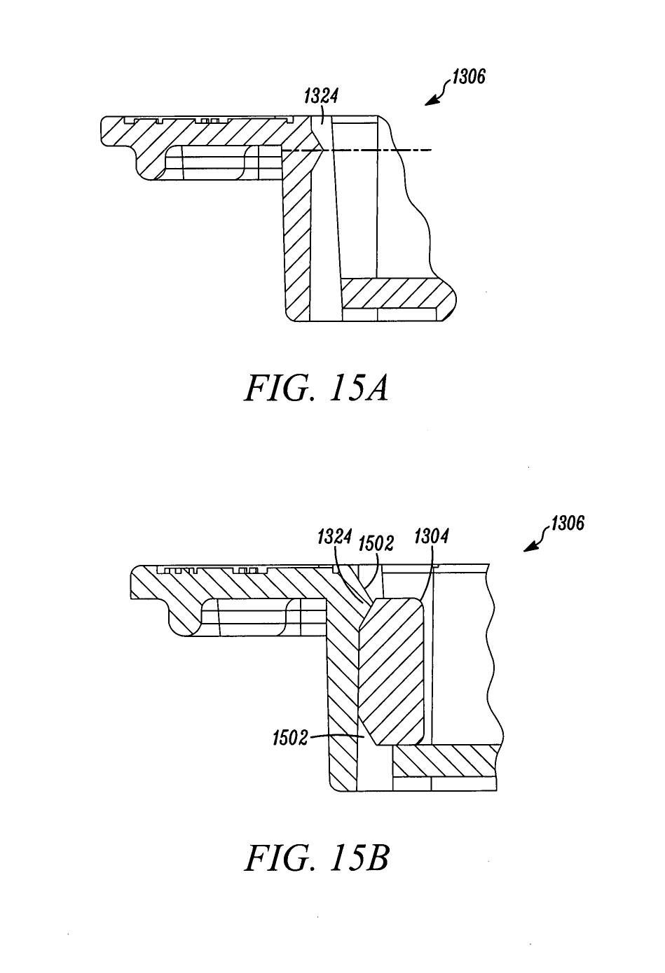

When the hinge sizing member 1302 is in a position corresponding to a maximum hinge size, the hinge sizing member 1302 and the fingers 1304 are in a position that is unconstrained by the track 1307 (e.g., by the distance “B” just discussed with respect to FIG. 15B). Nonetheless, it may be appreciated from FIG. 13 that in the maximum hinge size position, various surfaces, including surfaces 1322, of the hinge template 1300 may provide sufficient support for the hinge sizing member 1302 to prevent the hinge sizing member 1302 from moving out of the hinge template 1300 (e.g., rotating out of a plane of the opening 1313, as referenced above). Of course, this is just an example implementation, and in other embodiments, the tabs 1304 may be constrained by the track 1307 even in the maximum position. Similarly, the hinge sizing member 1302 may or may not be constrained by the track 1307 when in the minimum hinge size position (e.g., all the way toward a bottom recess of the recesses 1306). In the example of FIG. 13, the finger 1304 may be maintained by a bottom recess 1306a, which is below the rest of the recesses or slots 1306, so that if the hinge sizing member 1302 is in a minimum hinge size position then an additional movement/ratcheting of the finger 1304 from the recess 1306a may be required in order to position the tab 1311 within the exit point 1310 for removal of the hinge sizing member 1302 from the template 1300.

Referring further to FIG. 13, a ridge 1324 may be seen within slot 1306. Referring to FIGS. 15A and 15B, it may be seen that the ridge 1324 may abut against chamfers or angled surfaces 1502 of the ratcheting finger 1304, so that at least one of the surfaces 1502 abuts after assembly against a corresponding ridge(s) 1324, depending on a position of the finger 1304. That is, the ridge 1324 is illustrated without being in contact with the angled surface 1502, since the finger 1304 is illustrated as being at a lower position and positioned against ridge 1324 thereat. This construction helps ensure that the finger 1304 is maintained in position during use of the template 1300. In FIG. 15A, then, the ridge 1324 is illustrated without the finger 1304 being in position, while FIG. 15B illustrates an abutment of the angled surface 1502 of the finger 1304 against the ridge 1324.

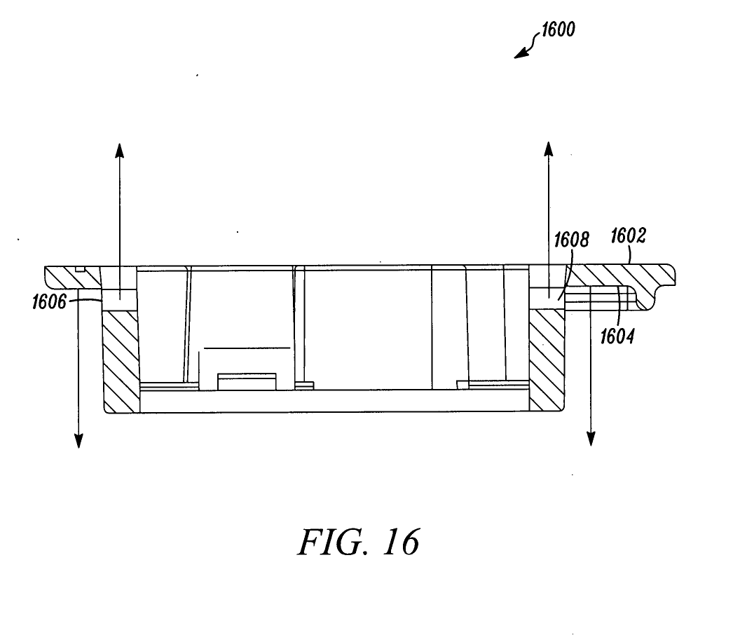

FIG. 16 is a cut-away view of a die mold 1600 for forming the ratcheting finger mechanism of FIG. 13, or, more specifically, is used to form the track 1307. In FIG. 16, the die mold 1600 includes a cover half 1602 and an ejector half 1604 that may be joined together during the die casting process. The portion of the die mold 1600 of FIG. 16 corresponds generally to form a portion of the track 1307 corresponding to a cut-away view BB of FIG. 13, although in the configuration of FIG. 16 it will be appreciated that the ejector half 1604 (although shown at a bottom of FIG. 16) forms a top surface of the track 1307 as shown in FIG. 13, while the cover half 1602 (although shown at a top of FIG. 16) forms a bottom surface of the track 1607 as shown in FIG. 13.

In FIG. 16, at least the ejector half 1604 includes openings and areas through which the molten material to be formed may flow to form the track 1607. However, the ejector half 1604 meets the cover half 1602 at points 1606 and 1608, so that no material may flow there. Consequently, when the cover half 1602 and the ejector half 1604 are separated after drying/solidifying of the molten material, an opening is formed as the track 1607, and having a lip formed thereover that constrains the finger 1304 along the distance “B” of FIG. 14B.

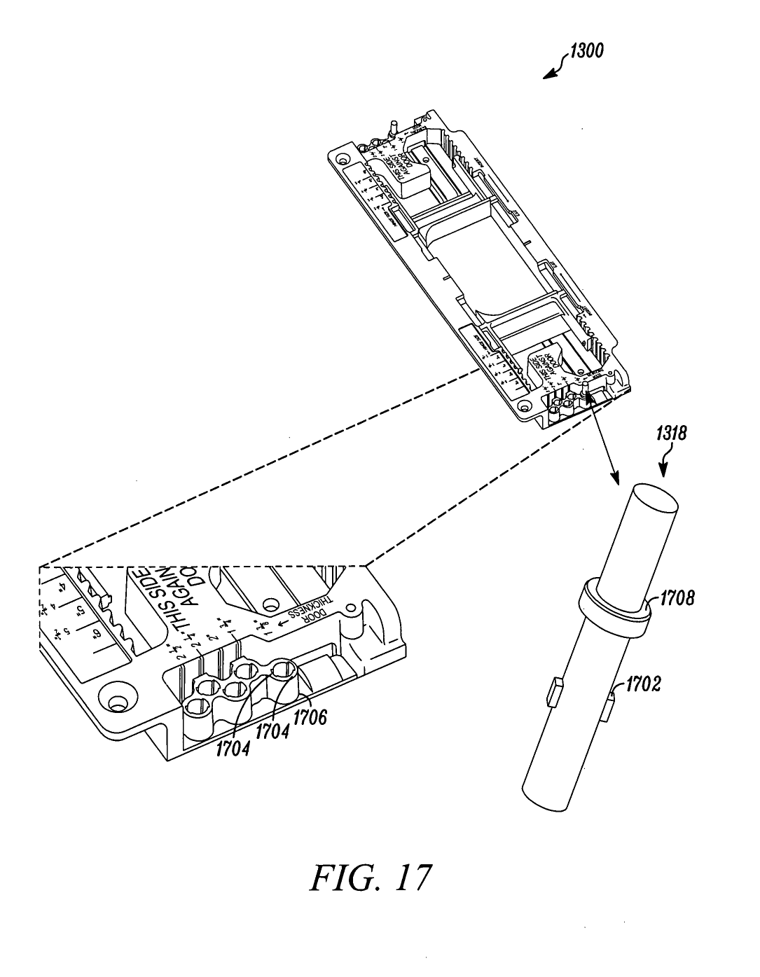

FIG. 17 is a perspective view with selected blow-ups of a locking pin mechanism for setting selectable door widths using the hinge template 1300. More specifically, the locking pin 1318 is illustrated as including two opposing tabs 1702 that may be inserted into corresponding slots 1704 of an opening 1706 of the hinge template 1300. That is, as described above with reference to FIGS. 1A, 6, and 13 (e.g., throughbores 114 or apertures 612), and as illustrated in those figures and in FIG. 17, the opening 1706 may be one of a number of openings that correspond to different door widths or thicknesses, as marked on the hinge template 1300.

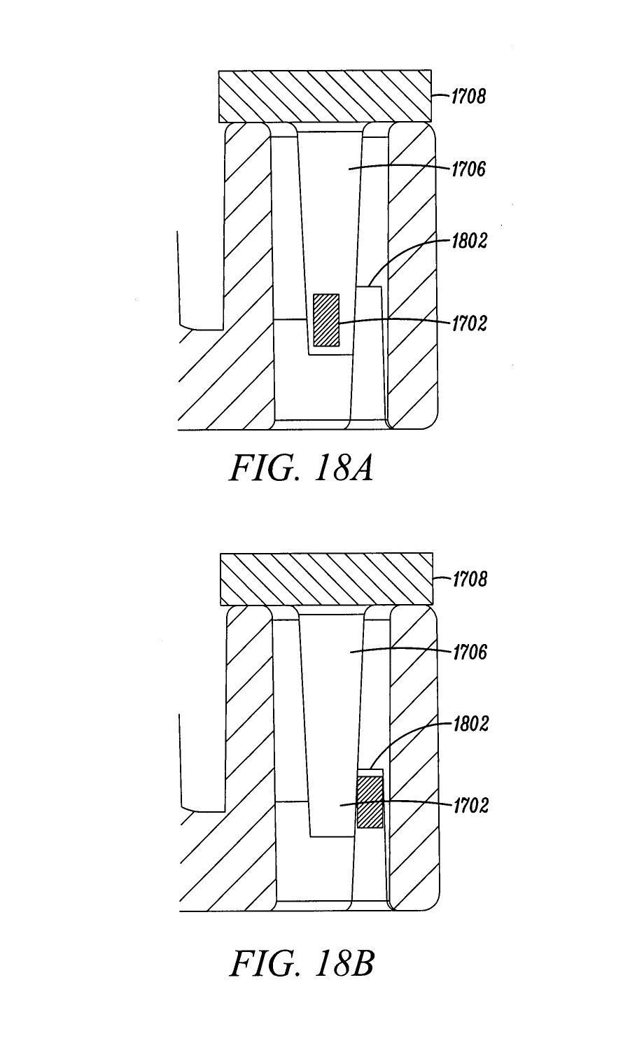

Upon alignment of the tabs 1702 with the slots 1704 of the opening 1706, the locking pin 1318 may be inserted up to a collar or surface 1708, and then the locking pin 1318 may be rotated to be engaged with corresponding surfaces within the opening 1706. For example, as shown in FIG. 18A, the locking pin 1318 may first be inserted into the opening 1706 until the surface 1708 engages a top surface of the opening 1706. In this position, as shown, the tabs 1702 are merely inserted into the slots 1704, but are not engaged within the opening 1706.

Then, in FIG. 18B, the locking pin 1318 may be rotated into a position in which the tabs 1702 are engaged underneath a surface 1802 within the opening 1706. The surface 1802 may slope downward in the azimuthal direction (i.e., around the circumference of the opening 1706), such that the top of the tabs 1702 engages progressively tighter with the surface 1802 as the locking pin 1318 is rotated, causing the locking pin 1318 to be locked in place. In this way, the locking pin 1318 may be firmly and reliably maintained in contact with the hinge template 1300, for reliable setting of the corresponding hinges/mortises, yet may be easily removed simply by rotating the locking pin 1318 in a reverse direction and sliding the tabs 1702 back through the slots 1704.

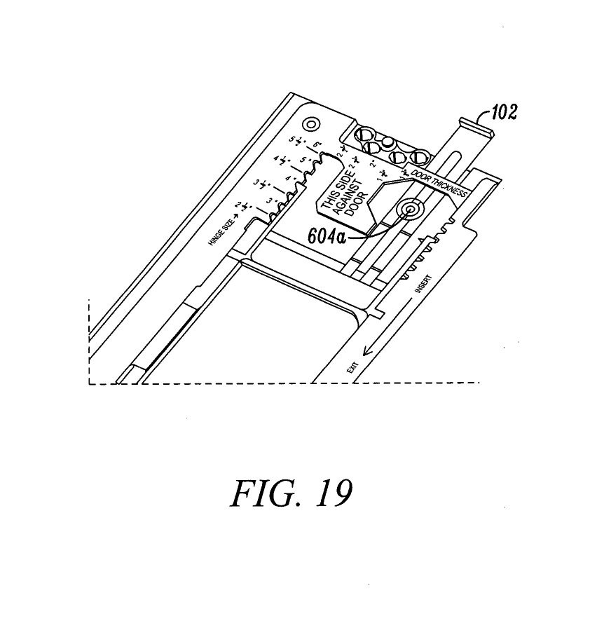

Although the discussion above of any particular implementation may be provided with or without reference to the gap spacer 102, it will be appreciated that various forms of the hinge templates described herein may be provided with or without the gap spacer 102, or other features or attachments. That is, virtually any combination of the described features may be implemented that may be advantageous in installing hinges, mortises, or doors, or performing related work or repair. For example, FIG. 19 is a perspective view of the door hinge template of FIG. 13, but including the gap spacer 302 of FIG. 3. As shown therein, the gap spacer 302, including the various associated features and functionalities described above with respect to FIGS. 3-9, e.g., a variation of the rotatable locking clamp 604, shown as clamp 604a in FIG. 19, may easily be incorporated into the door hinge template 1300 of FIG. 13.

Many other implementations are possible. For example, referring to FIGS. 20A and 20B, in one embodiment, a template 2000 includes a body 2002 having a top alignment portion 2004, a central portion 2006, and a bottom alignment portion 2008. On the underside of body 2002 is an alignment surface 2010. The central portion defines a generally rectangular opening 2012 with a curved corner 2014. The opening 2012 is defined by a plurality of walls 2040, 2042, 2044, 2046. Received in the opening 2012 is an insert 2016 having a side wall 2018 and a curved corner 2020 having a radius that is substantially the same as the radius of curved corner 2014. Insert 2016 has tabs (not shown) that are received in a plurality of recesses 2022 to adjust the position of the insert 2016 relative to opening 2012 to adjust the effective size of the opening 2012. Template 2000 may include a plurality of inserts 2016 that correspond to a plurality of hinge sizes and configurations. At the edges of body 2002 are a plurality of nail holes 2003, each of which are sized and configured to receive a nail therethrough.

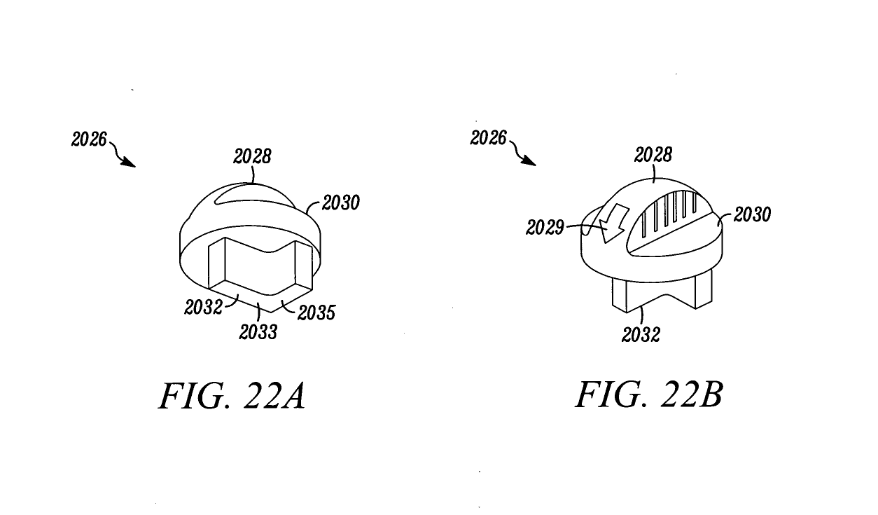

Each of the top and bottom alignment portions 2004, 2008 define a bore 2024 that receives an alignment adjustment knob 2026 therethrough. Referring also to FIGS. 22A and 22B, the adjustment knob 2026 includes a disk-shaped portion 2030 received in the bore 2024, a half-moon shaped actuator portion 2028 that extends from the disk shaped portion 2030 above the body 2002, and an L-shaped projection 2032 that extends from the disk shaped portion 2030 below the alignment surface 2010. L-shaped projection 2032 has a long leg 2033 and a short leg 2035 so that when the L-shaped projection 2032 is rotated the distance between the projection and the edge of the body changes to accommodate different sizes and orientations of doors. The half moon actuator 2028 includes am indicator 2029 that points to one of four position markings 2034 (FIG. 20A) that correspond to the different sizes and orientations of doors and door frames. Adjustment knob 2026 can be permanently attached to template 2000 or can be removably attached to template 2000 so that bores 2024 can receive knobs 2026 having projections having different sizes and/or configurations.

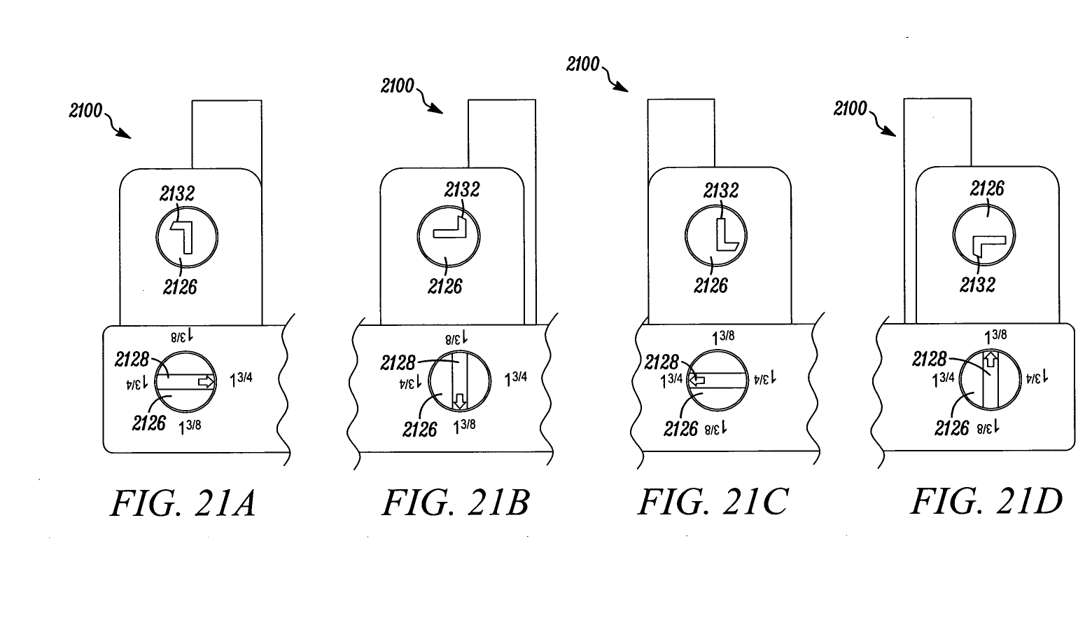

Referring to FIGS. 21A and 21B, in use, the alignment surface 2010 is placed against the side surface of the doorjamb, and the adjustment knob is rotated to the position that corresponds to the size and orientation of the door (e.g., 1.750 inches and left handed as shown in FIG. 21A, 1.375 inches and left handed as shown in FIG. 21B, 1.750 inches and right handed as shown in FIG. 21C, and 1.375 inches and right handed as shown in FIG. 21D). Adjustment knob 2026 can be rotated without removing adjustment knob 2026 from template 2000. As shown in FIGS. 20A and 20B, the template 2000 is aligned with the door jamb by causing the L-shaped projection 2032 to abut against the door edge, such that the appropriate leg of the L abuts against the door edge. The template 2000 is affixed to the doorjamb by driving a nail through two or more of nail holes 2003, and the opening 2012 is used to guide a cutting instrument, such as a router, to cut a mortise for a hinge into the doorjamb. Once the door mortise is complete, the template 2000 is removed from the door jamb, and is attached to the door frame in the same manner as the door jamb in order to form a corresponding mortise in the door frame.

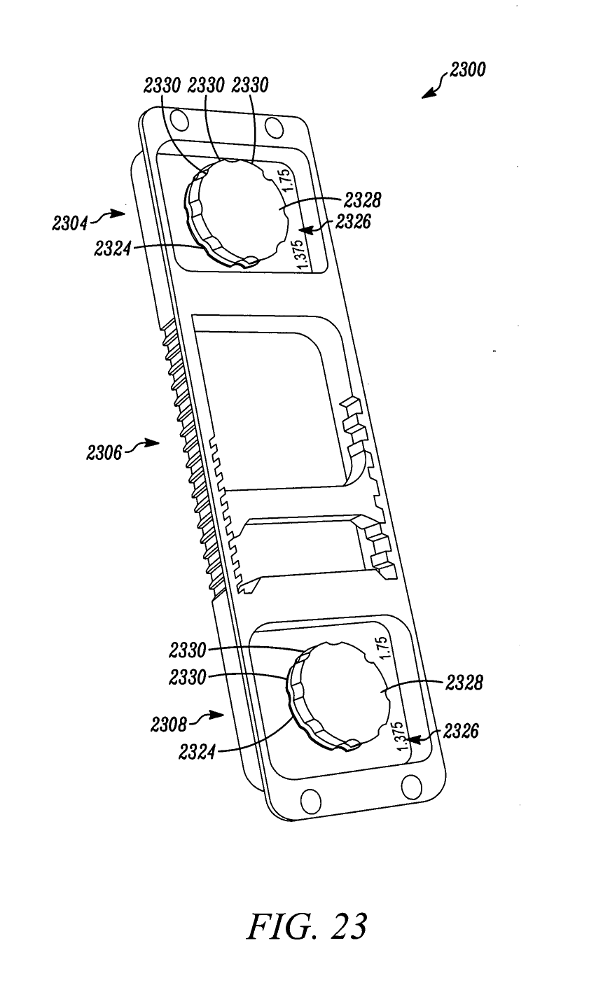

Referring to FIG. 23, in an alternative embodiment, a template 2300, similar in configuration to template 2000, includes top and bottom alignment portions 2304 and 2308 that each define a bore 2324 therethrough. Received in each bore 2324 is an adjustment knob 2326 that is similar in configuration to adjustment knob 2026, except that adjustment knob 2326 includes an actuator portion 2328 with a knurled perimeter 2330 configured to be gripped by a user.

Numerous modifications may be made to the exemplary implementations described above. For example, rather than a rotatable adjustment knob, the alignment portion can include a slot and the alignment member can include a slidable tab that fits into the slot, where the slidable tab is slidable between two or more discrete positions in the slot. The projections from the rotatable adjustment knob can have a different number and/or shape to accommodate larger or smaller sizes of doors. For example, the adjustment knob can have a pin-shaped projection, a triangular projection to accommodate three positions and three door sizes, or the adjustment knob can have a hexagonal projection to accommodate three sizes of doors in both left and right orientations. The inserts can be eliminated or can be coupled in a different manner to the templates. Different sizes and shapes of inserts may be used with the templates. Multiple templates may be linked by a single linking member of fixed length. A greater or fewer number of hinge templates may be linked. The door length and hinge length markings may be on other parts, e.g., on the connecting members or on the templates themselves. These and other implementations are within the scope of the following claims.

1. A door hinge template comprising:
a body defining a central portion and at least one alignment portion that extends from the central portion;
an opening defined in the central portion, the opening configured to guide a cutting instrument to form the mortise for the hinge in a surface of a doorjamb and in a corresponding surface of a door frame; and
first and second substantially parallel alignment surfaces disposed on opposite sides of each of the at least one alignment portions, wherein the first alignment surface is configured to abut against the surface of the door when forming the mortise in the door jamb and the second alignment surface is configured to abut against the surface of the door frame when forming the mortise in the door frame.

2. The door hinge template of claim 1, wherein the first alignment surface includes a first marking indicating placement of the first alignment surface against the surface of the door when forming the mortise in the door jamb, and wherein the second alignment surface includes a second marking indicating placement of the second alignment surface against the surface of the door frame when forming the mortise in the door frame.

3. The door hinge template of claim 1, wherein the central portion includes at least one hinge sizing member having a curved guide surface for forming a curvature of the mortise in the door jamb and the mortise in the door frame.

4. The door hinge template of claim 1, wherein the central portion includes at least one hinge sizing member configured to move within the opening to correspond to a size of the hinge.

5. The door hinge template of claim 4, wherein the central portion includes at least two hinge sizing members configured to move relative to one another within the opening to correspond to the size of the hinge.

6. The door hinge template of claim 4, wherein the body of the hinge template includes a plurality of hinge size markings, with respect to which the at least one hinge sizing member may be set to designate the size of the hinge.

7. The door hinge template of claim 4, wherein the at least one hinge sizing member is configured to move within the opening in a direction substantially parallel to the first and second alignment surfaces.

8. The door hinge template of claim 4, wherein the body of the hinge template includes a plurality of slots, each slot corresponding to a different hinge size, and wherein the at least one hinge sizing member includes at least one extension leg that extends in a direction of the at least one alignment portion, the at least one extension leg including a tooth configured to fit within a selected one of the plurality of slots for selection thereby of the size of the hinge.

9. The door hinge template of claim 8, wherein the tooth is configured to ratchet between the plurality of slots in a direction from a maximum hinge size to a minimum hinge size.

10. The door hinge template of claim 1, wherein the door hinge template comprises:
a track formed in the body; and
at least one hinge sizing member configured to form a size of the opening, the hinge sizing member including a tab configured to slide within the track in a direction substantially parallel to the first and second alignment surfaces for positioning of the at least one hinge sizing member at one of a plurality of positions corresponding to a plurality of sizes of the opening.

11. The door hinge template of claim 10, wherein the track is configured to restrain movement of the tab, and thereby restrain movement of the at least one hinge sizing member, in a direction perpendicular to the first and second alignment surfaces.

12. The door hinge template of claim 1, wherein the central portion includes a center line marking positioned to designate a center of the opening, and thereby designate a center of the mortise in the doorjamb and of the mortise in the door frame

13. The door hinge template of claim 1, wherein the at least one alignment portion includes a plurality of apertures configured to receive an alignment pin, wherein the plurality of apertures correspond to a plurality of door sizes.

14. The door hinge template of claim 13, wherein a selected one of the plurality of apertures is configured to receive the alignment pin therethrough, and wherein the alignment pin extends beyond the first alignment surface when the first alignment surface abuts the surface of the door and extends beyond the second alignment surface when the second alignment surface abuts against the surface of the door frame.

15. The door hinge template of claim 13, wherein a selected one of the plurality of apertures is configured to receive the alignment pin therethrough, and wherein the alignment pin abuts against the door during formation of the mortise in the door jamb and abuts against the door frame during formation of the mortise in the door frame.

16. The door hinge template of claim 13, wherein:
the alignment pin includes a plurality of tabs at one end thereof,
the plurality of apertures each include a corresponding plurality of slots to receive the plurality of tabs, and
the plurality of slots each include an internal surface,
further wherein the alignment pin is configured for locking into place within a selected one of the plurality of apertures by insertion of the tabs into the corresponding slots and subsequent rotation of the alignment pin to thereby position the tabs within the slot and in contact with the internal surface.

17. The door hinge template of claim 1, comprising:
a gap spacer extending from the body, the gap spacer configured for tactile alignment with a bottom of a surface of the door frame when forming the mortise in the door frame and configured for tactile alignment with a top of the door when forming the mortise in the door jamb.

18. The door hinge template of claim 1, wherein the body is coupled to a connecting member configured to receive a linking member, for assembly therewith of a plurality of door hinge templates for forming a first plurality of mortises in the door frame and a second plurality of mortises in the door jamb.

19. The door hinge template of claim 1, wherein the connecting member is disposed for alignment with hinge size markings or door size markings on the linking member.

20. A method of creating a door hinge mortise in a door jamb and a corresponding door hinge mortise in a door frame, the method comprising:
placing a door hinge template against the door frame;
guiding a cutting implement along walls of an opening in the door hinge template to form the door hinge mortise in the door frame;
placing the door hinge template against the doorjamb without changing the orientation of the door hinge template relative to the door jamb and door frame; and
guiding a cutting implement along walls of the opening in the door hinge template to form the door hinge mortise in the doorjamb.

21. The method of claim 20 wherein placing the door hinge template against the door frame comprises:
adjusting a hinge sizing member of the door hinge template based on a desired size of the door hinge mortise in the door frame.

22. The method of claim 20 wherein placing the door hinge template against the door frame comprises:
placing a gap spacer attached to the door hinge template in contact with the door frame to position the door hinge template relative to a bottom surface of the door frame, wherein the gap spacer has a thickness substantially equivalent to a desired gap between a top surface of the door and the bottom surface of the door frame.

23. The method of claim 20 wherein placing the door hinge template against the door jamb without changing the orientation of the door hinge template relative to the door jamb and door frame comprises:
removing a first alignment surface of the door hinge template from against the door frame; and
positioning a second alignment surface that is substantially parallel to the first alignment surface against the door jamb.

24. A door hinge template comprising:
a body defining a central portion, a top alignment portion, and a bottom alignment portion, the top and bottom alignment portions extending from the central portion, the body including a first plurality of slots and a second plurality of slots;
an opening defined in the central portion by a top hinge sizing member and a bottom hinge sizing member, the opening configured to guide a cutting instrument to form a mortise for a hinge in a surface of a doorjamb and in a corresponding surface of a door frame, wherein the top hinge sizing member includes a top toothed member configured to ratchet within and between the first plurality of slots to position the top hinge sizing member, and wherein the bottom hinge sizing member includes a bottom toothed member configured to ratchet within and between the second plurality of slots to position the bottom hinge sizing member;
first and second substantially parallel alignment surfaces disposed on opposite sides of each of the top and bottom alignment portions, wherein the first alignment surface is configured to abut against the surface of the door when forming the mortise in the door jamb and the second alignment surface is configured to abut against the surface of the door frame when forming the mortise in the door frame;
a plurality of apertures corresponding to different door thicknesses and configured to receive an alignment pin therethrough for abutment thereof against the door when forming the mortise in the door jamb and for abutment thereof against the door frame when forming the mortise in the door frame; and
a gap spacer extending from the body, the gap spacer configured for tactile alignment with a bottom of a surface of the door frame when forming the mortise in the door frame and configured for tactile alignment with a top of the door when forming the mortise in the door jamb.

25-36. (canceled)
